(19) United States
(12) Patent Application Publication
(10) Pub. No.: US 2026/0231101 A1
(43) Pub. Date: Aug. 6, 2026

(54) ADAPTIVE UPLINK FREQUENCY HOPPING

(71) Applicant: InterDigital Patent Holdings, Inc., Wilmington, DE (US)

(72) Inventors: Fumihiro Hasegawa, Westmount (CA); Tao Deng, New York, NY (US); Paul Marinier, Brossard (CA); Tuong Hoang, Montreal (CA); Moon IL Lee, Melville, NY (US); Janet Stern-Berkowitz, Little Neck, NY (US)

(73) Assignee: InterDigital Patent Holdings, Inc., Wilmington, DE (US)

(21) Appl. No.: 19/155,144

(22) PCT Filed: Feb. 8, 2024
(86) PCT No.: PCT/US2024/014971

§ 371 Date: Aug. 8, 2025

Related U.S. Application Data
(60) Provisional application No. 63/445,061, filed on Feb. 13, 2023.

(51) Int. Cl. H04W 64/00; H04B 17/318; H04L 5/00

(52) U.S. Cl. CPC H04W 64/00; H04B 17/328; H04L 5/0012; H04L 5/0051

(57) ABSTRACT

A wireless transmit/receive unit (WTRU) may receive configuration information. The configuration information may indicate a configured bandwidth for performing positioning reference signal (PRS) measurements. The WTRU may receive a first PRS transmission using a first portion of the configured bandwidth. The first portion of the configured bandwidth may correspond to a first frequency hop associated with the configured bandwidth. The WTRU may receive a second PRS transmission using a second portion of the configured bandwidth. The second portion of the configured bandwidth may correspond to a second frequency hop of the configured bandwidth. The WTRU may determine a PRS measurement based on the first PRS transmission and/or the second PRS transmission. The WTRU may send the PRS measurement and an indication of whether the measurement was based on multiple frequency hops.

### CROSS-REFERENCE TO RELATED APPLICATIONS

This application claims the benefit of U.S. Provisional Patent Application No. 63/445,061, filed on Feb. 13, 2023, the entire contents of which are incorporated herein by reference.

### BACKGROUND

This disclosure pertains to devices, methods, and systems for enabling frequency hopping for positioning.

### SUMMARY

A wireless transmit/receive unit (WTRU) may receive configuration information. The configuration information may indicate a configured bandwidth for performing positioning reference signal (PRS) measurements. The WTRU may receive a first PRS transmission using a first portion of the configured bandwidth. The first portion of the configured bandwidth may correspond to a first frequency hop associated with the configured bandwidth. The WTRU may receive a second PRS transmission using a second portion of the configured bandwidth. The second portion of the configured bandwidth may correspond to a second frequency hop of the configured bandwidth. The WTRU may determine a PRS measurement based on the first PRS transmission and/or the second PRS transmission. The WTRU may send the PRS measurement and an indication of whether the measurement was based on multiple frequency hops.

In some cases, the first and the second portion of the configured bandwidth may be different. The first and second portion of the configured bandwidth may overlap in frequency or may not overlap in frequency. The WTRU may be a reduced capability WTRU that is not configured to perform PRS measurements across the entirety of the configured bandwidth during a given time instance. The WTRU may receive the first and the second PRS transmissions in consecutive hops.

The PRS measurement may comprise a reference signal time difference (RSTD), reference signal received power (RSRP), and/or a WTRU receive-transmit time difference measurement. The indication that the determined PRS measurement is based on more than one frequency hops may be indicated by a single bit, an integer, a real number, or a different data type. The PRS measurement may comprise a first measurement based on the first PRS transmission, and a second measurement determined based on the second PRS transmission. In some cases, the WTRU may determine the PRS measurement by determining raw measurements from both the first PRS transmission and the second PRS transmission, and then performing a calculation to determine the PRS measurement (e.g., average, minimum, maximum).

### BRIEF DESCRIPTION OF THE DRAWINGS

A more detailed understanding may be had from the following description, given by way of example in conjunction with the accompanying drawings, in which like reference numerals in the figures indicate like elements.

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A.

FIG. 1C is a system diagram illustrating an example radio access network (RAN) and an example core network (CN) that may be used within the communications system illustrated in FIG. 1A.

FIG. 1D is a system diagram illustrating a further example RAN and a further example CN that may be used within the communications system illustrated in FIG. 1A.

FIG. 2 shows an example configuration of frequency hopping for SRS.

FIG. 3A and FIG. 3B illustrate examples of frequency hopping patterns.

FIG. 4A illustrates an example repetition applied to a pattern. FIG. 4B illustrates an example repetition applied to each hop in a pattern.

FIG. 5A illustrates an example of PRS with a comb-4 pattern. FIG. 5B illustrates an example of PRS with a comb-2 pattern.

FIG. 6 illustrates examples of parameters for a measurement gap.

FIG. 7A illustrates an example repetition of patterns for PRS. FIG. 7B illustrates an example repetition of hops in a pattern for PRS.

FIG. 8 illustrates an example hierarchy of PRS configuration parameters.

FIG. 9 illustrates an example of parameters for Rx hopping.

FIG. 10 illustrates an example of WTRU behavior when PRS is enabled or disabled, in which the normal PRS encompasses PRS hopping bandwidth.

FIG. 11 illustrates an example coherent combining.

FIG. 12A and FIG. 12B illustrate example frequency hopping patterns.

FIG. 13 illustrates an example detection of a collision prior to a preparation time.

FIG. 14 illustrates an example selection of a hopping pattern that avoids collision.

FIG. 15 illustrates an example of exchanges of signals between the network and a WTRU.

FIG. 16 illustrates an example of an overlap of time and frequency resources with scheduled uplink transmission and SRS frequency hops.

FIG. 17 illustrates an example of an overlap of time and frequency resources with scheduled uplink transmission and SRS frequency hops.

FIG. 18 illustrates an example of scheduling of PUCCH transmission between SRS frequency hops.

FIG. 19 illustrates an example of detection of a collision during preparation.

FIG. 20 illustrates an example of WTRU behavior after a detection of the collision during preparation time.

FIG. 21 illustrates an example of periodic transmission of SRS hops and collision with uplink channel.

FIG. 22 illustrates an example of RSTD measurement for an occasion of frequency hops.

FIG. 23 illustrates an example of a per-hop pair RSTD measurements.

FIG. 24 illustrates an example measurement on a partial occasion of hops.

FIG. 25 illustrates an example measurement on a partial occasion of hops.

FIG. 26 illustrates an example of a hop window.

FIG. 27 illustrates an example of prioritization between a downlink channel and PRS when the WTRU is expected to perform prioritization during the window duration.

FIG. 28 illustrates an example of prioritization between a downlink channel and PRS when the WTRU is expected to perform prioritization over overlapped occasion.

FIG. 29 illustrates an example of prioritization between a downlink channel and PRS when the WTRU is expected to perform prioritization over an occasion.

FIG. 30 illustrates an example of collision behavior for repetition in which the WTRU is configured to process measurements for surviving hops.

FIG. 31 illustrates an example of collision behavior for repetition in which the WTRU is configured to process measurements for a downlink channel.

FIG. 32 illustrates an example of collision behavior for repetition in which the WTRU is configured to process measurements on PRS hops.

FIG. 33 illustrates an example computation of a round trip time.

FIG. 34 illustrates an example of a coherently combined WTRU Rx-Tx time.

FIG. 35 illustrates an example of pairwise determination of a WTRU Rx-Tx time.

FIG. 36 illustrates an example of determination of WTRU Rx-Tx time based on partial measurements.

FIG. 37 illustrates an example of per hop measurement for Rx hopping.

FIG. 38 illustrates an example of combining measurements from repeated measurements.

FIG. 39A and FIG. 39B illustrate examples of Rx hopping patterns based on a configured number of repetition factors.

FIG. 40 illustrates an example of measurement per Rx hopping occasion.

FIG. 41A and FIG. 41B illustrate examples of Rx hopping patterns.

FIG. 42 illustrates an example of Rx hopping for RSTD measurements.

### DETAILED DESCRIPTION

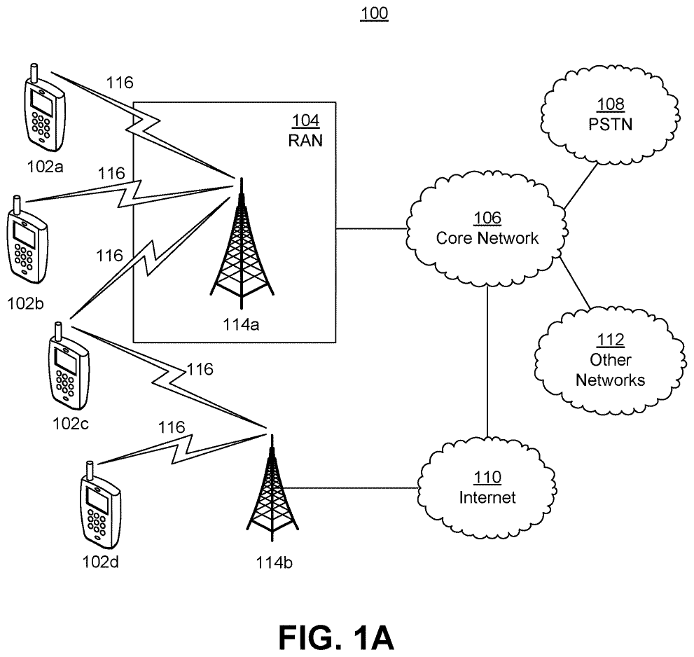

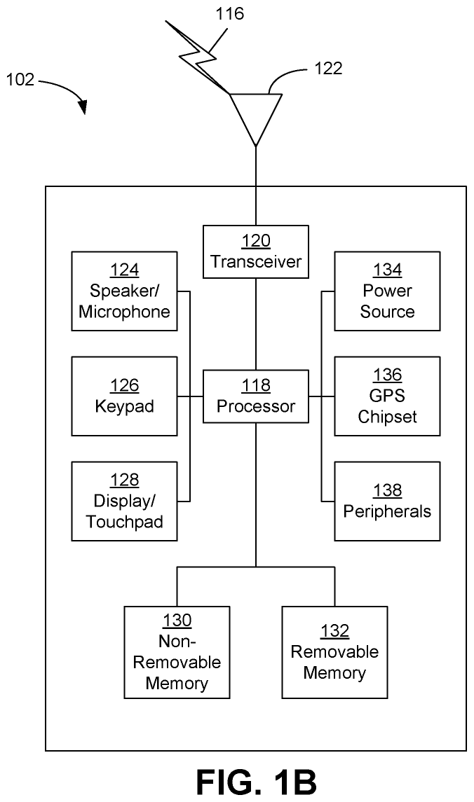

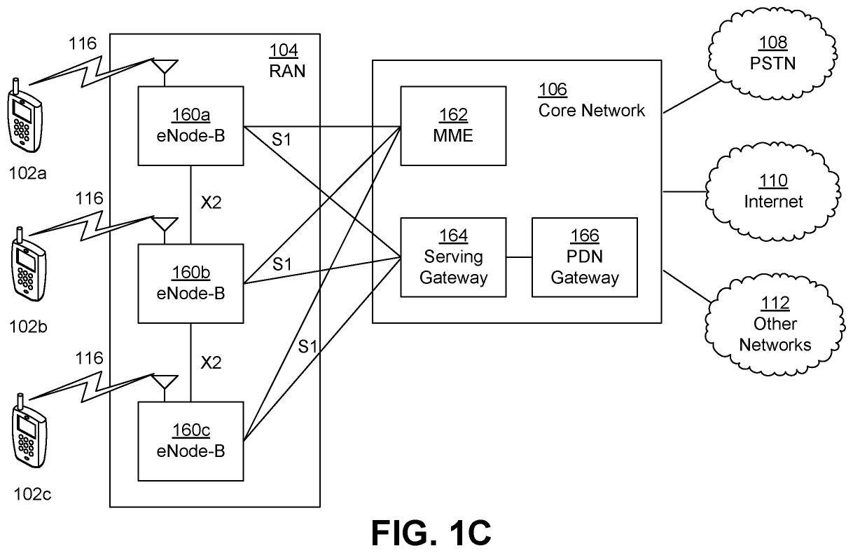

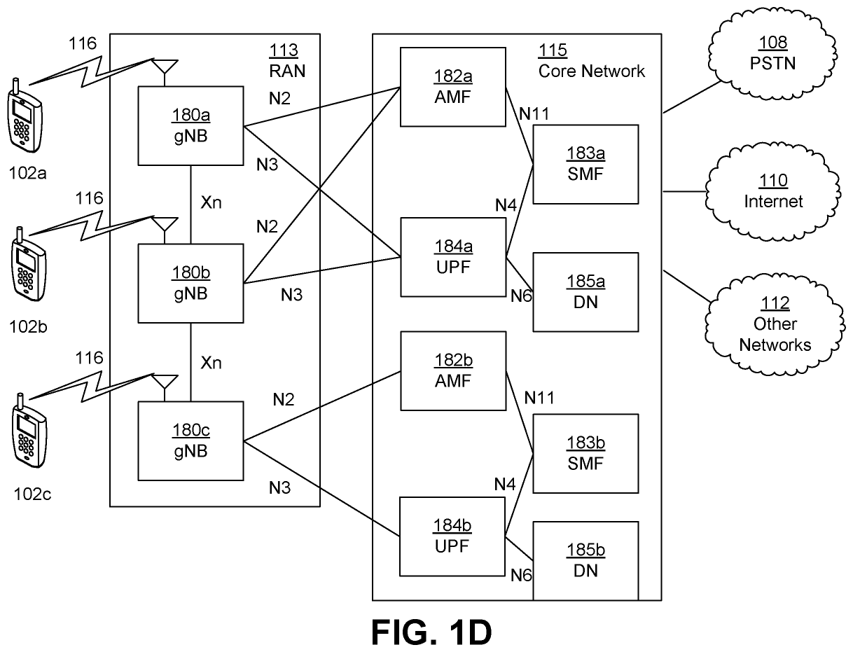

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, in which the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUS 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

The following abbreviations and acronyms, among others, are used herein: Acknowledgement (ACK); Angle of Arrival (AoA); Angle of Departure (AoD); Absolute Radio-Frequency Channel Number (ARFCN); Block Error Rate (BLER); Bandwidth (BW); Bandwidth Part (BWP); Channel Access Priority (CAP); Channel access priority class (CAPC); Clear Channel Assessment (CCA); Control Channel Element (CCE); Control Element (CE); Configured Grant or Cell Group (CG); Control Resource Set (CORESET); Cyclic Prefix (CP); Conventional OFDM (relying on cyclic prefix) (CP-OFDM); Channel Quality Indicator (CQI); Cyclic Redundancy Check (CRC); Channel State Information (CSI); Contention Window (CW); Contention Window Size (CWS); Channel Occupancy (CO); Downlink Assignment Index (DAI); Downlink Control Information (DCI); Downlink feedback information (DFI); Dynamic grant (DG); Downlink (DL); Demodulation Reference Signal (DM-RS); Data Radio Bearer (DRB); Discontinuous Reception (DRX); Enhanced Cell ID (ECID); enhanced Licensed Assisted Access (eLAA); enhanced Mobile Broadband (eMBB); Further enhanced Licensed Assisted Access (FeLAA); Hybrid Automatic Repeat Request (HARQ); Interference Measurement (IM); License Assisted Access (LAA); Listen Before Talk (LBT); Logical Channel (LCH); Logical Channel Priority (LCP); Listen-Before-Talk (LBT); Line of Sight (LOS); Non Lie of Sight (NLOS); Location Management Function (LMF); LTE Positioning Protocol (LPP); Long Term Evolution (e.g., from 3GPP LTE R8 and up) (LTE); Control Element MAC (CE MAC); Medium Access Control (MAC); Modulation and Coding Scheme (MCS); Multiple Input Multiple Output (MIMO); Negative ACK (NACK); Non-access stratum (NAS); New Radio (NR); Orthogonal Frequency-Division Multiplexing (OFDM); Observed Time Difference of Arrival (OTDOA); Physical Downlink Control Channel (PDCCH); Physical Downlink Shared Channel (PDSCH); Packet Data Unit (PDU); Physical Layer (PHY); Process ID (PID); Paging Occasion (PO); Physical Random Access Channel (PRACH); Positioning Reference Signal (PRS); Positioning Reference Unit (PRU); Primary Synchronization Signal (PSS); Phase Tracking Reference Signal (PTRS); Physical Uplink Control Channel (PUCCH); Physical Uplink Shared Channel (PUSCH); Random Access (or procedure) (RA); Random Access Channel (RACH); Random Access Response (RAR); Radio access network Central Unit (RCU); Resource Element (RE); Radio Front end (RF); Radio Link Failure (RLF); Radio Link Monitoring (RLM); Radio Network Identifier (RNTI); RAN Notification Area (RNA); RACH occasion (RO); Radio Resource Control (RRC); Radio Resource Management (RRM); Round Trip Time (RTT); Reception Point (RP); Reference Signal (RS); Reference Signal Received Power (RSRP); Reference Signal Time Difference (RSTD); Round Trip Time (RTT); Received Signal Strength Indicator (RSSI); Relative Time of Arrival (RTOA); Service data adaptation protocol (SDAP); Service Data Unit (SDU); Signaling Radio Bearer (SRB); Sounding Reference Signal (SRS); Synchronization Signal (SS); Secondary Synchronization Signal (SSS); Switching Gap (in a self-contained subframe) (SWG); Semi-persistent scheduling (SPS); Supplemental Uplink (SUL); Transport Block (TB); Transport Block Size (TBS); Time Difference of Arrival (TDoA); Transmission-Reception Point (TRP); Time-sensitive communications (TSC); Time-sensitive networking (TSN); Transmission Time Interval (TTI); Uplink Control Information (UCI); Uplink (UL); Ultra-Reliable and Low Latency Communications (URLLC); Wide Bandwidth Part (WBWP); Wireless Local Area Networks and related technologies (IEEE 802.xx domain) (WLAN).

In some implementations, a WTRU may select a hopping sequence for SRS frequency hopping. The WTRU may select the hopping sequence based on the timing of detection of a collision between at least one of the SRS hops and a scheduled uplink channel transmission. In some implementations, the WTRU may determine to perform one RSTD measurement per hop-pair or hop occasion. The WTRU may determine to perform RSTD measurement per hop-pair or hop occasion based on a channel condition (e.g., a Line of Sight (LOS) indicator). In some implementations, the WTRU may determine to perform a Reference Signal Received Power (RSRP) measurement per Rx hop or hop occasion. The WTRU may determine to perform an RSRP measurement per Rx hop or hop occasion based on a channel condition (e.g., a LOS indicator). The WTRU may determine a Rx hopping pattern based on a selection criterion.

Devices, methods, and systems for adaptive measurements for frequency hopping are discussed herein. In some implementations, the WTRU may receive (e.g., from a network) positioning reference signal (PRS) configurations and/or configurations for PRS hopping pattern. In some implementations, the WTRU may perform downlink (DL)-time difference of arrival (TDOA). In some implementations, the WTRU may receive (e.g., from the network) configuration about pairing of hops. A pair of hops may include a hop index for PRS transmitted from a reference transmission reception point (TRP) and/or target TRPs, wherein each hop pair is associated with a pair index. In some implementations, the WTRU may receive a line-of-sight (LOS) indicator associated with the PRS transmitted from the reference TRP from the network. In some implementations, the WTRU may report RSTD(s) (e.g., an RSTD based on all hops of an RSTD per paired hops) to the network.

In some implementations, the PRS configurations may include a reference and target TRP identifier (ID) and/or a PRS resource ID. In some implementations, the network may include a location management function (LMF) and/or a gNodeB (gNB). In some implementations, the configurations for PRS hopping pattern may include one or more of a number of hops in one occasion of hops, a duration of each hop, a PRS hopping pattern for reference, and/or a target TRP ID. In some implementations, a hopping pattern may include a set of at least two hops per hopping occasion. A hopping occasion may correspond to a time unit (e.g., symbol or slot) and/or a time span of multiple time units. In some implementations, a hopping pattern may include two or more hops. Each such hop may be associated with an ID (e.g., index). In some implementations, a first hop in a hopping occasion may correspond to a first set of frequency resources and a second hop in a hopping occasion may correspond to a second set of frequency resources. The first and the second set of frequency resources may or may not overlap. The second set of frequency resources may be different than the first set of frequency resources. In some implementations, both target and reference TRPs may transmit PRS (e.g., according to the same frequency hopping pattern). For example, if a hopping pattern of PRS transmitted from target and reference TRP includes two hops, hop #1 and hop #2, a first pair of hops may comprise hop #1 from the reference TRP and hop #1 from the target TRP, and a second pair of hops may comprise hop #2 from reference TRP and hop #2 from target TRP. In some implementations, the WTRU may perform one or more RSTD measurements (e.g., for all hops) when the LOS indicator is greater than or equal to a threshold and receiving all hops in the occasion. In some implementations, the WTRU may perform an RSTD measurement (e.g., per received paired hop) based on the LOS indicator being below the threshold and receiving both hops in a pair of hops, in which an RSTD measurement is associated with the pair index.

Communications systems may use downlink, uplink and downlink, and/or uplink positioning methods. The positioning methods include but are not limited to: DL positioning method(s), UL positioning method(s), and/or DL & UL positioning method(s).

A “DL positioning method” may refer to any positioning method that uses downlink reference signals (e.g., PRS). A WTRU may receive multiple reference signals from TP(s) and measure DL RSTD and/or RSRP. Examples of DL positioning methods may include, for example, DL-AoD or DL-TDOA positioning, etc.

A “UL positioning method” may refer to any positioning method that uses uplink reference signals (e.g., SRS for positioning). The WTRU may transmit SRS to multiple RPs and the RPs may measure the UL RTOA and/or RSRP. Examples of UL positioning methods may include, for example, UL-TDOA or UL-AoA positioning, etc.

A “DL & UL positioning method” may refer to any positioning method that uses both uplink and downlink reference signals for positioning. In some embodiments, a WTRU may transmit SRS to multiple TRPs and a gNB may measure the Rx-Tx time difference. The Rx-Tx time difference may be calculated based on the time of arrival of DL RS (e.g., PRS). The gNB may measure RSRP for the received SRS. The WTRU may measure Rx-Tx time difference for PRS transmitted from multiple TRPs. The WTRU may measure RSRP for the received PRS. The Rx-TX difference and/or the RSRP measured at the WTRU and gNB may be used to compute round trip time. “WTRU Rx-Tx time difference” may refer to the difference between an arrival time of the reference signal transmitted by the TRP and a transmission time of the reference signal transmitted from the WTRU. DL & UL positioning method may include, for example, multi-RTT positioning, etc.

The “Network” may include one or more AMF, LMF, gNB and/or NG-RAN. The terms “pre-configuration” and “configuration” may be used interchangeably as presented herein. The terms “non-serving gNB” and “neighboring gNB” may be used interchangeably as presented herein. The terms “gNB” and “TRP” may be used interchangeably as presented herein. The terms “PRS”, “SRS”, “SRS for positioning” or “SRS for positioning purpose” may be used interchangeably as presented herein. The terms “PRS” or “PRS resource” may be used interchangeably as presented herein. The terms “PRS(s)” or “PRS resource(s)” may be used interchangeably as presented herein. In some cases, the aforementioned “PRS(s)” or “PRS resource(s)” may belong to different PRS resource sets. The terms “PRS” or “DL-PRS” or “DL PRS” may be used interchangeably as presented herein. The terms “measurement gap” or “measurement gap pattern” may be used interchangeably as presented herein. In some cases, a “measurement gap pattern” may include parameters including but not limited to, a measurement gap duration, measurement gap repetition period, and/or measurement gap periodicity.

In some cases, a PRU may be a WTRU or TRP whose location (e.g., altitude, latitude, geographic coordinate, or local coordinate) is known by the network (e.g., gNB, LMF). The PRU may have capabilities similar to or the same as the capabilities of a WTRU or TRP. For example, the PRU may be capable of receiving PRS or transmitting SRS or SRS for positioning, returning measurements, and/or transmitting PRS. The WTRUs acting as PRUs may be used by the network for calibration purposes (e.g., correct unknown timing offset, correct unknown angle offset).

In some cases, an LMF is a non-limiting example of a node or entity (e.g., network node or entity) that may be used for or to support positioning. Any other node or entity may be substituted for LMF and still be consistent with the disclosure provided herein.

In some cases, the WTRU may receive a preconfigured threshold(s) from the network (e.g., LMF, gNB).

In some cases, the LOS indicator may be a hard indicator (e.g., 1 or 0) or a soft indicator (e.g., 0, 0.1, 0.2 . . . , 1) and indicates a likelihood of the presence of an LOS path between TRP and WTRU or along PRS. The LOS indicator may be associated with a TRP or PRS resource ID (e.g., index). In some cases, the WTRU may receive the LOS indicator from the network per TRP or resource ID. In other cases, the WTRU may determine the LOS indicator per TRP, or resource ID based on measurements. In one or more cases, “ID” and “index” may be used interchangeably.

In some cases, during a PRS processing window, the WTRU may be configured to prioritize PRS or DL channel over DL channel (e.g., PDCCH, PDSCH) or PRS, respectively, according to the priority configured by the network. Compared to other UL channels (e.g., PUCCH, PUSCH), SRS or SRS for positioning may be associated with a lower priority. As such, the WTRU may postpone or cancel SRS transmission. Reduced Capability (RedCap) WTRUs may not be able to transmit or measure signals with wide bandwidth. A RedCap WTRU may be able to transmit and/or receive signals with small bandwidth. In such cases, DL RS, such as PRS, may be transmitted via frequency hopping to cover a large BW. However, not all hops may not be received by the WTRU due to lower priority of PRS. SRS/SRS for positioning may have the lowest priority compared to other UL channels, and the transmission for SRS/SRS for positioning may be dropped to prioritize uplink channels with higher priority. Further, for timing/power-based positioning (e.g., RTT-based positioning, DL/UL TDOA based positioning, and the like), loss of a hop may deteriorate performance and increase latency. As such, solutions to ensure reception of all PRS/SRS hops transmitted by the network or WTRU may improve accuracy and lower latency during positioning and/or data communication.

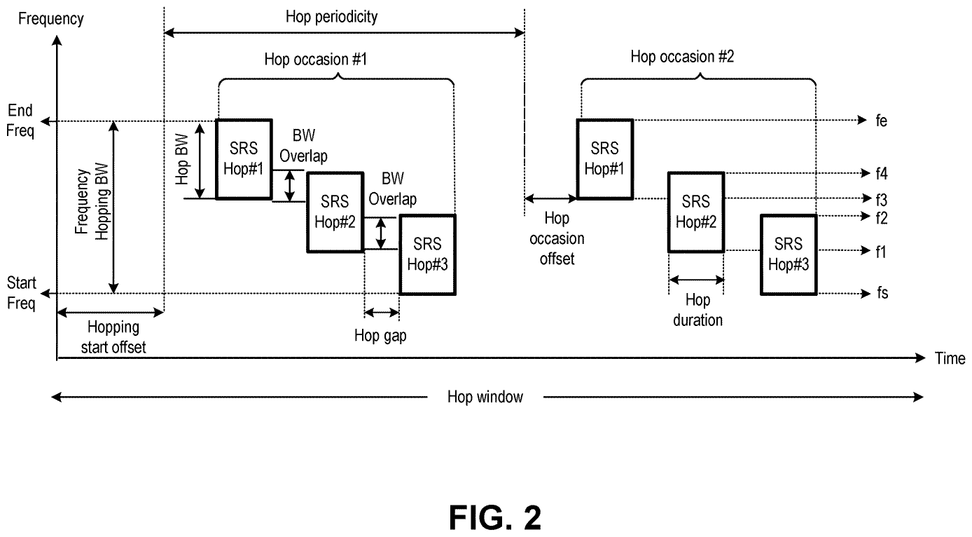

In some cases, a WTRU may be configured to perform Tx hopping. FIG. 2 illustrates an example of a frequency hopping pattern and parameters for frequency hopping configurations. SRS may be used in frequency hopping patterns. FIG. 2 illustrates an example of parameters for configuring a frequency hopping pattern. The WTRU may be configured with parameters, as further discussed herein, by the network (e.g., gNB, LMF). Additionally, or alternatively, signal types other than SRS may be used in frequency hopping patterns. Herein, SRSp, SRS or PRS may be used interchangeably to illustrate parameters for configuration of a frequency hopping pattern. For example, any parameters used to describe SRS hopping (e.g., hop occasion, hop BW, hop gap, and the like) may be applicable to PRS hopping.

In some cases, The WTRU may determine frequency hopping configuration parameters (e.g., such as parameters for PRS and/or SRS hopping) from a message received from the network (e.g., LPP, RRC, MAC-CE, DCI, broadcast such as SIB). The WTRU may receive configurations and/or pre-configurations related to Tx or Rx hopping from the network. Some configurations may be preset configurations or “preset.” For example, the configurations may be pre-programmed in the WTRU, and the network may be aware of the WTRU's preprogrammed configurations, such that announcement, messaging, and/or configuration from the network is not needed.

In some cases, a hop may be represented by a range of frequency. For example, the hopping pattern shown in FIG. 2 may be represented by [(fs, f2), (f1, f4), (f3, f3)] in which each hop represents a range of frequencies, indicated by the lowest and highest frequency in the range, and a pattern is a sequence of hops. The WTRU may follow the pattern to make measurements on different bands in the received PRS. The frequency range may be represented in terms of a frequency unit, such as, but not limited to, Hz, RE ID number/number or RB ID number/number.

A hopping pattern may include a set of two or more hops per hopping occasion. A hopping occasion may correspond to a time unit (e.g., symbol or slot) or time span of multiple time units. The terms “occasion”, “group” and/or “instance” may be used interchangeably as presented herein.

A first hop in a hopping occasion may correspond to a first set of frequency resources. In some cases, a second hop in a hopping occasion may correspond to a second set of frequency resources that overlaps. In some cases, the second hop in a hopping occasion may correspond to a second set of frequency resources that does not overlap with the first set of frequency resources but is not the same as the first set of frequency resources.

In some cases, the WTRU may be configured with BW per hop. All hops may have the same BW in the pattern (e.g., bwh=f1−f4). The WTRU may be configured with the start frequency for each hop. The start frequency may be represented by a differential between the start frequency for each hop and the lowest frequency in the frequency hopping BW (e.g., the reference frequency). For example, the pattern in FIG. 2 may be represented by [d3, d1,0], in which the reference frequency is fs, and d3=f3−fs and d1=f1−fs. The reference frequency may be configured by the network. In some cases, the reference frequency may be configured to be the lowest frequency, the highest frequency, or the center frequency of the frequency hopping BW. The frequency range may be represented in terms of a frequency unit, such as, but not limited to, Hz, RE ID number/number or RB ID number/number.

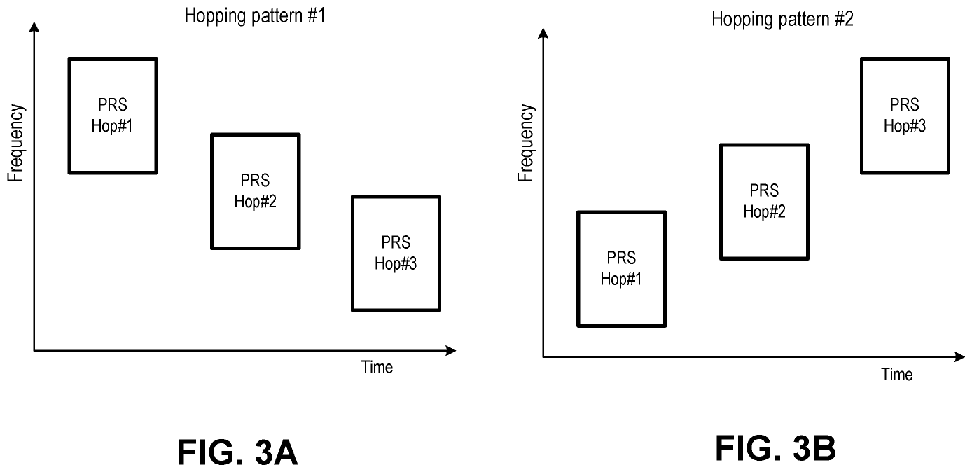

In some cases, The WTRU may receive a configuration and/or indication indicating a frequency hopping pattern from a list (e.g., the pattern index to use for transmission). The list may include one or more PRS/SRS hopping patterns. Each pattern may be associated with an index. A hopping pattern may include a set of two or more hops per hopping occasion. A hopping occasion may correspond to a time unit (e.g., symbol or slot) or time span of multiple time units. FIG. 3A and FIG. 3B illustrate different PRS frequency hopping pattern examples.

In some cases, existing PRS configuration(s) may be associated with PRS hopping configuration parameter(s). A WTRU may determine a PRS hopping configuration based on the PRS configuration for normal PRS (e.g., PRS transmission which does not use a hopping pattern). Normal PRS and PRS hops may differ some ways. For example, one occasion of PRS may encompass 20 MHz and in contrast, using PRS hopping that includes 5 MHz bandwidth per hop may require 4 hops, in which each hop may not overlap in the frequency domain, to encompass 20 Mhz.

In some cases, an association between existing PRS configuration(s) and PRS hopping configuration parameter(s) may be used to reduce signaling overhead. In examples, the WTRU may determine the PRS hopping pattern based on the PRS repetition factor configured by the network. Since the PRS repetition factor is used as a part of the normal PRS configuration, signaling overhead may be reduced by associating the existing parameter (e.g., a PRS repetition factor) and PRS hopping parameters. For example, each repetition occasion may correspond to each hop. Thus, if the WTRU is configured with the PRS repetition factor of four by the network, in addition to the indication of enabling PRS frequency hopping, the WTRU may determine that there are four PRS hops in a pattern. At the next repetition occasion, the WTRU may expect to receive a PRS hop instead of the normal PRS. In some cases, the WTRU may be preconfigured (e.g., by the network) with a mapping table that maps the repetition factor to a pattern.

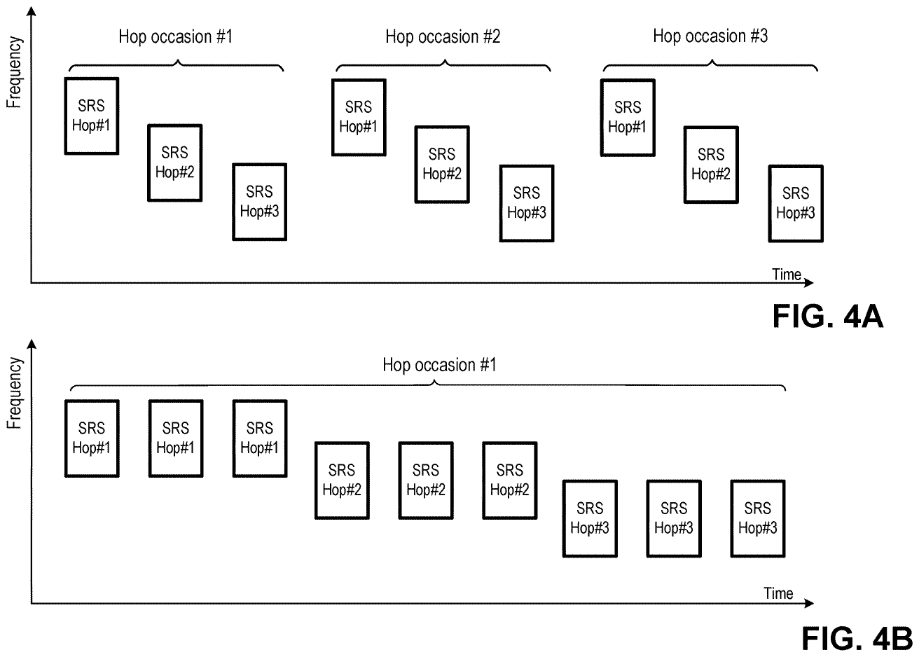

FIG. 4A and FIG. 4B illustrate examples of two occasions of hops. An occasion may be defined as the event at which frequency hopping transmission is configured to take place. The WTRU may receive configurations (e.g., periodicity, duration, starting position in the time/frequency domain) for occasions. In some cases, each occasion may be a repetition of a frequency hopping pattern (e.g., as illustrated in FIG. 2). In some cases, each occasion may be a different frequency hopping pattern.

As illustrated in FIG. 4A, the WTRU may receive a configuration for repetition of PRS hops. In some cases, a repetition may be applied to a hop or pattern. For the cases in which repetition is applied per hop, repeated hops may constitute one occasion (e.g., each). FIG. 4A illustrates an example of repetition applied to a pattern, in which a repetition factor of 3 is applied to a pattern that includes of 3 occasions.

As illustrated in FIG. 4B, the WTRU may receive a configuration for repetition applied to each hop in a pattern. Further, FIG. 4B illustrates as an example in which a repetition factor of 3 is applied to each hop in a pattern. As such, the resulting occasion includes 9 hops.

In some cases, the WTRU may be configured to transmit/receive one or more (e.g., all) SRS/PRS hops in an occasion in one slot (e.g., 2 PRS hops in one slot). The WTRU may be configured to transmit/receive one or more (e.g., all) SRS/PRS hops across more than one slot (e.g., 4 PRS hops across 2 slots in which the first 2 PRS hops and the last 2 PRS hops are scheduled in the first and second slot, respectively). The WTRU may be configured to transmit/receive one or more (e.g., all) SRS/PRS hops in one BWP (e.g., 2 PRS hops in one BWP) or across more than one BWP (e.g., 4 PRS hops across 2 BWPs, in which the first 2 PRS hops and the last 2 PRS hops are scheduled in BWP #1 and BWP #2, respectively).

In some cases, the WTRU may be configured with frequency domain characteristics of a hopping pattern. The frequency domain related configurations of a frequency hopping pattern may be expressed as follows. A one hop pattern may include more than one hop, in which each hop starts at a unique frequency. The frequency hopping bandwidth may indicate the bandwidth covered by the hops in the frequency hopping pattern. The start and end of a frequency hopping bandwidth may be expressed in terms of start frequency or end frequency, respectively. Additionally, or alternatively, the frequency hopping bandwidth can be expressed in terms of the start frequency, bandwidth of each hop in the pattern, bandwidth overlap between consecutive hops and a number of hops in the group. In examples, the start frequency and/or end frequency may be expressed in terms of an absolute frequency, an RB or RE number, an RB or RE ID number, etc. Each hop in the frequency hopping pattern may be characterized by hop BW (e.g., as illustrated in FIG. 2).

The center, lowest, and/or highest frequency of each hop may be expressed in terms of an offset with respect to the start frequency and/or end frequency of the frequency hopping BW. The offset may be expressed in terms of frequency unit (e.g., Hz, RE, RB).

In some cases, the WTRU may be configured with time domain characteristics of a hopping pattern. The time domain related configuration of a frequency hopping pattern may be expressed as follows. In examples, a duration of a frequency hopping pattern may be expressed in terms of a hop duration, a time gap between two consecutive hops, a duration of a hop (e.g., expressed in terms of slots, symbols), a number of hops, a time offset from the start time of the hop occasion (e.g., a “hop occasion offset”), etc. In some cases, the gap between consecutive hops may be configured such that phase coherency between the consecutive hops is maintained. For example, the WTRU may be configured to maintain the phase coherency between the consecutive hops such that a difference between phase of the last OFDM symbol in the (n−1)th hop and first OFDM symbol in the nth hop is smaller than a threshold.

The WTRU may receive configurations for the start time with respect to a reference time (e.g., the first symbol/slot in a grant, the first symbol in a slot, etc.).

The WTRU may determine the number of hops in a pattern based on the latency requirement. For example, if the WTRU is required to report measurements in N seconds, the WTRU may determine that M hops in a pattern are configured by the network. In some cases, the WTRU may be preconfigured with a mapping table, by the network. The WTRU may be preconfigured with a mapping table that associates a latency requirement with a number of hops in a pattern and/or number of repetition factors in PRS. In an example, based on the configured latency requirement by the network, the WTRU may determine the number of repetition factors or hops in a pattern associated with the latency requirement.

In some cases, the WTRU may be configured to determine a hop gap. For example, the WTRU may determine the gap between each hop based on at least PRS/SRS configuration. The PRS/SRS configuration may include one or more of the following: subcarrier spacing, center frequency, resource ID, resource set ID, frequency layer ID, duration of cyclic prefix, etc. The WTRU may determine that the gap between each hop is associated with subcarrier spacing. In some cases, the WTRU may be configured from the network with a mapping table between at least one of the PRS configurations and length of the gap. The WTRU may determine the length of the gap according to the mapping table. For example, the WTRU may determine that the gap is 6 OFDM symbols for 15 kHz subcarrier spacing. In examples, the WTRU may determine that the gap is 3 symbols for 30 kHz subcarrier spacing.

In some cases, the WTRU may determine the length of the gap based on the function of hopping parameters (e.g., duration of hop occasion, BW overlap). For example, the WTRU may determine the length of the gap based on the BW overlap between two consecutive hops in the frequency domain. The WTRU may be configured with the duration of the hopping pattern in time units (e.g., symbols, slots, and/or seconds). The WTRU may determine the duration of the gap based on the number of hops and/or the duration of each hop in the pattern. For example, if the number of hops is 2 and the duration of the pattern is 14 symbols, and a hop is 4 symbols, then the WTRU may determine that the gap between each hop is 6 symbols, which may be derived based on 14 symbols−2 hops*4 symbols/hop.

In some cases, the WTRU may determine the length and/or gap between occasions and/or repetitions based on WTRU capability. In some cases, the WTRU may determine the length and/or gap between occasions and/or repetitions based on the coverage of the hopping pattern in the frequency domain. For example, if the WTRU is configured with a PRS/SRS frequency hopping pattern in which consecutive hops are located in different BWPs (e.g., hop #1 in BWP #1 and hop #2 in BWP #2), the WTRU may be preconfigured with a gap length between consecutive hops, repetitions, or occasions, which is a function of the frequency switching time. The frequency switching time may be a time or duration required for the WTRU to retune frequency for transmission and/or reception of SRS/PRS hop. The WTRU may be preconfigured with a mapping table that associates the gap length and frequency switching time (e.g., a gap of 10 symbols may be associated with a switching time of 5 symbols).

In some cases, the WTRU may be configured to determine a BW overlap. The WTRU may determine a BW overlap based on a configuration. For example, the WTRU may determine a BW overlap between consecutive PRS hops based on subcarrier spacing, a BWP index, and/or a frequency hopping bandwidth. The WTRU may be preconfigured with a mapping table that maps a BWP index and a BW overlap. For example, according to the mapping table and/or rule(s), the WTRU may determine that consecutive hops located in BWP1 may overlap by 1 RB (resource block), while consecutive hops located in BWP2 may overlap by 2 RB. In some examples, according to the preconfigured mapping table and/or rule(s), the WTRU may determine that consecutive hops with a subcarrier spacing of 15 kHz may overlap by 2 RB, while consecutive hops with a subcarrier spacing of 30 kHz may overlap by 1 RB.

In some examples, the WTRU may receive an indication and/or a configuration from the network that there is no overlap between two consecutive PRS/SRS hops. The indication and/or configuration may include, for example, RRC, LPP, MAC-CE, DCI, etc.

In some examples, the WTRU may determine the BW overlap based on one or more of a hop BW, frequency hopping BW, and/or a number of hops. For example, if a frequency hopping BW, a number of hops, and a hop BW are 20 MHz, 2 hops and 12 MHz, respectively, then the WTRU may determine that the BW overlap is 4 MHz. In this example, the WTRU may derive the BW overlap of 4 MHz based on 12 MHz/per hop*2 hops−20 MHz. In some cases, the WTRU may be configured to determine the starting frequency of the second hop based on one or more of the starting frequencies of the first hop, a BW overlap, and/or a hop BW.

The WTRU may determine an amount of overlap in hops in the frequency based on a comb pattern. The WTRU may receive, from the network, a mapping table that associates the amount of the BW overlap and comb values. In some examples, if the WTRU is configured with PRS with a comb-4 pattern, the WTRU may determine (e.g., from the mapping table) that the amount of overlap between two consecutive frequency hops is 1 RB. In some examples, if the WTRU is configured with PRS with a comb-2 pattern, the WTRU may determine, from the mapping table, that the amount of overlap between two consecutive frequency hops is 2 RBs.

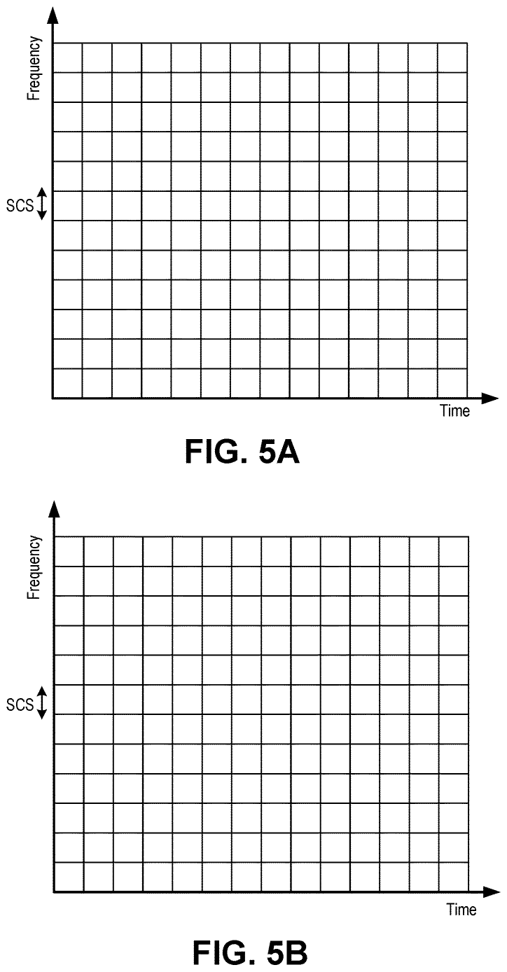

FIG. 5A illustrates an example of PRS with a comb-4 pattern. FIG. 5A illustrates a comb-4 pattern having 12 OFDM symbols with 12 resource elements, in which SCS denotes subcarrier spacing. FIG. 5B illustrates an example of PRS with a comb-2 pattern. FIG. 5B illustrates a comb-2 pattern having 12 OFDM symbols with 12 resource elements, in which SCS denotes subcarrier spacing. In FIG. 5A and FIG. 5B, more than one comb pattern is placed in the time domain. For example, FIG. 5A illustrates a pattern that includes the first, second, third and fourth OFDM symbols. The pattern repeats through the fifth, sixth, seventh and eight OFDM symbols, and so on.

The WTRU may determine the BW overlap for PRS hop reception and/or SRS hop transmission based on the channel condition. The channel condition may include, for example, frequency selectivity, Doppler shift/frequency, etc. The WTRU may be configured with a mapping table that associates one or more range(s) of Doppler shift/frequency and BW overlap. A range may include a minimum value and/or a maximum value. For a larger Doppler shift/frequency, the larger BW overlap may be utilized for the WTRU/network to maintain phase continuity. In some examples, the WTRU may be configured with a mapping table that associates a number of paths detected in the channel and BW overlap. The WTRU may determine the BW overlap based on the channel condition and/or mapping table.

In some cases, the WTRU may be configured with a hop window. The WTRU may receive one or more configurations related to the hop window. During a hop window, the WTRU may be configured to transmit and/or receive one or more occasions of a configured pattern of frequency hops. During a hop window, the WTRU may be configured by the network to introduce an offset in the time domain when transmitting the first occasion of frequency hopping. The WTRU may introduce the offset expressed in terms of units (e.g., slots, symbols, seconds, frames, etc.). The WTRU may be configured with a hop periodicity. In some cases, the hop periodicity may indicate how often the WTRU should transmit hops following the configured frequency hopping pattern. The periodicity may be expressed in terms of time units (e.g., slots, symbols, seconds, frames, etc.). The time window may be expressed in terms of a combination of a start time and/or end time. The start time may be expressed in terms of slot #, frame #, absolute time, etc. The duration of the window may be expressed in terms of time units (e.g., slots, symbols, seconds, frames, etc.).

The WTRU may be configured with more than one hop window. In some cases, each hop window may include one or more hop occasions. The WTRU may be configured with one or more of a start time of each hop window, an end time of each hop window, a periodicity of a hop window, and/or time offset of a hop window with respect to the reference timing (e.g., start of a UL grant). The WTRU may receive a configuration or indication that the hop window may be aligned with other UL transmission configurations, such as configured grants or dynamic grants.

In some cases, the WTRU may be configured with a common grid and/or a different grid for frequency hopping. The WTRU may be configured with a set of PRS resources for RX frequency hopping and/or TX transmission hopping. In some examples, a PRS resource configuration may include one or more of an SCS, a frequency bandwidth, a starting frequency location, a center frequency location, and/or a PRC comb pattern. The frequency bandwidth may indicate the number of RBs of a PRS resource. The starting frequency location may indicate a starting RB of the PRS resource. The center frequency position may indicate a center RB of the PRS resource. In some examples, the indication of a starting and/or center RB location may be based on an RB index. The RB index may be specific to a resource block grid.

In some cases, a starting and/or center RB location of a configured DL PRS resource may be based on a resource block grid used by a gNB for DL operation. A gNB may determine the resource block grid based on the SCS, center frequency, and/or frequency bandwidth of a NR carrier including SSB transmissions. A gNB resource block grid reference point may be (pre)configured to indicate a reference start point in the gNB resource block grid. In some examples, a gNB resource block grid reference point may be the lowest sub-carrier of the lowest RB of the gNB resource block grid (e.g., sub-carrier and/or RB with index of zero). A WTRU may determine a gNB resource block grid reference point based on a SSB frequency location (e.g., of a PCell) and/or frequency offset information indicated in a received corresponding SIB. A WTRU may determine a frequency location corresponding to a starting and/or center RB of a configured DL PRS resource based on the sub-carrier and/or RB index of the starting and/or center RB and the determined gNB resource block grid reference point. When a WTRU performs RX hopping to receive a configured DL PRS, a WTRU may set a receiving bandwidth (e.g., a RedCap WTRU active BWP) equal to the number of RBs indicated in the DL PRS configuration. Additionally, or alternatively, when the WTRU performs RX hopping to receive a configured DL PRS, the WTRU may set a starting or centered frequency location based on the configured starting or center RB index.

In some cases, DL PRS resources may be configured in any NR carrier and/or BWP available to gNB(s) without SSB transmission. This may enable more configuration flexibility, (e.g., a DL PRS resource allocation not in a different NR carrier and/or BWP in which a WTRU does not receive SSB). In some cases, a WTRU may be configured with a PRS resource based on a common resource block grid applicable for all PRS configurations. A common resource block grid may be (pre)configured for a PRS frequency layer. A common resource block grid may be indicated to a WTRU in SIB and/or dedicated RRC signaling. The (pre)configuration may include one or more of a SCS, a frequency bandwidth, a starting frequency location, a center frequency location, and/or a common resource block grid reference point. In some examples, a common resource block grid reference point may be indicated as the lowest sub-carrier of the lowest RB of the common resource block grid at an absolute frequency location. In some cases, the WTRU may be configured to determine the frequency location of the indicated starting and/or center RB of the PRS configuration based on the absolute frequency location corresponding to common resource block grid reference point.

In some cases, the WTRU may be (pre)configured and/or indicated with one or more WTRU resource block grids. A PRS configuration may be specific to an active WTRU resource block grid. An active WTRU resource block grid may be applied by a WTRU. The WTRU may apply a local resource reference point. The local resource reference point may be the lowest sub-carrier and/or RB of the WTRU resource block grid. The WTRU may determine the frequency location of the indicated starting and/or center RB of the PRS configuration based on the WTRU's own WTRU reference block grid and/or the local reference point.

In some cases, the WTRU may be configured to measure one or more of a time of arrival, a time of departure, and/or a transmission time. The WTRU may measure one or more of a time of arrival (ToA), a transmission time, and/or a time of departure (ToD) for SRS transmission. The WTRU may measure ToA or ToD in time units (e.g., an absolute time, a relative time with respect to a reference time such as an SSB reception time, a symbol index, a slot index, and/or a frame index).

In some cases, the WTRU may be configured to perform frequency hopping. The WTRU may receive a semi-static configuration (e.g., via RRC, LPP message, etc.) for transmission and/or reception of SRS/PRS frequency hops. For example, the semi-static configuration may include the parameters discussed herein related to frequency hops (e.g., hop BW).

In some examples, the WTRU may receive an activation and/or deactivation command for one or more hop window(s) from the network via an indicator. In examples, the indicator may be RRC, MAC-CE, DCI, LPP message, and/or other like messages. The WTRU can send a request to the network for activation and/or deactivation of a hop window (e.g., via an LPP message, MAC-CE, or UCI).

In some examples, the WTRU may receive a configuration (e.g., RRC, LPP message) indicating when the hop window starts or ends, and/or the periodicity of a hop window. One activation command may activate more than one hop window. Each hop window may be configured to occur with a configured periodicity. In some examples, one deactivation command may deactivate more than one hop window(s).

In some examples, (e.g., if the WTRU is configured with periodic transmission of SRS frequency hops) the WTRU may determine a periodicity of occasions of transmission of SRS frequency hops. The periodicity of occasions may be expressed in terms of slots, a number of symbols, frames, absolute time (e.g., seconds), or any other time unit. As such, the WTRU may determine periodic and/or semi-persistent occasions of transmission of SRS frequency hops.

A hop window may be aligned in the time domain or associated with other windows, such as measurement gaps or PRS processing window. For example, the WTRU may be configured to receive one or more PRS frequency hopping occasion(s) during a PRS processing window or measurement gap. The measurement gap and/or PRS processing window may be configured by the network (e.g., LMF, gNB).

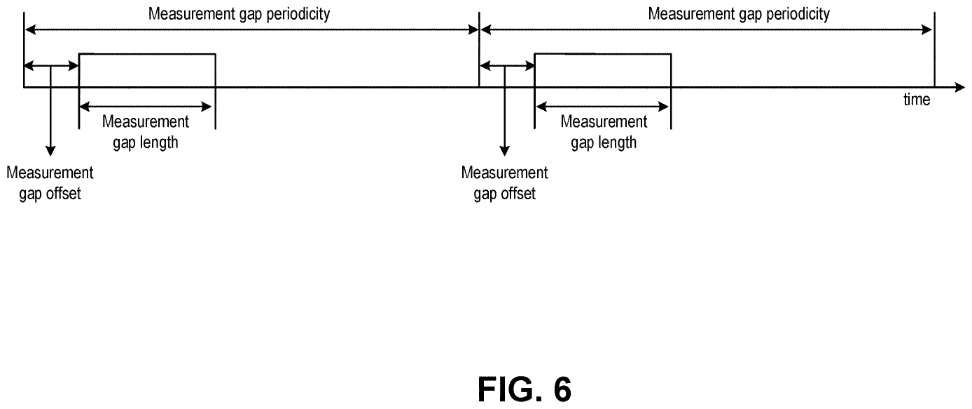

FIG. 6 shows examples of parameters (e.g., measurement gap periodicity, measurement gap length, and measurement gap offset) of a measurement gap or PRS processing window. Similar parameters (e.g., periodicity, length, and offset) may be defined for a PRS processing window. During the measurement gap, indicated by “measurement gap length” in FIG. 6, the WTRU may receive an indication and/or configuration to perform measurements on PRS and process the measurements. In some cases, the hop window may be aligned with the measurement gap during which the WTRU is expected to receive PRS frequency hops.

In some cases, the WTRU may be configured for a measurement gap for PRS frequency hops. The WTRU may receive PRS hopping configurations from the network. The PRS hopping configurations may include, for example, hopping duration and/or hop periodicity. The WTRU may send a request to the network to configure/activate a measurement gap (e.g., via RRC message, LPP, MAC-CE, UCI, etc.). In some examples, the WTRU may send a request by including an index for the measurement gap pattern. The WTRU may be preconfigured with a list of measurement gap patterns (e.g., a measurement gap, a duration of a measurement gap, etc.). The WTRU may determine to send a measurement gap to measure and process measurements made from the received PRS hops.

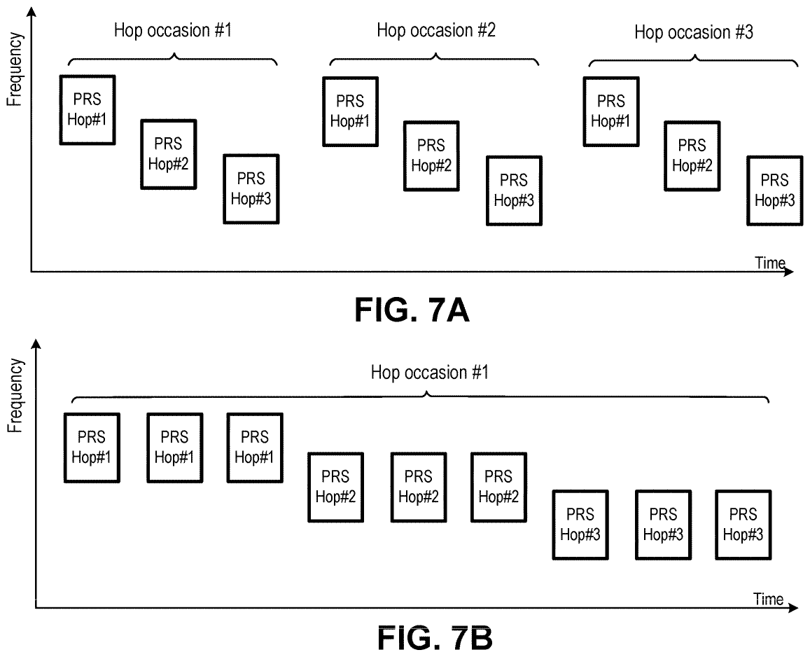

In some examples, the WTRU may determine to request one or more measurement gap based on configurations of a PRS pattern. The WTRU may determine to send a request for a measurement gap. The request may contain one or more of the following. FIG. 7A illustrates an example in which the WTRU is configured with repetitions of PRS hopping patterns. The request in FIG. 7A may be a request to configure a measurement gap in which the gap duration and/or gap periodicities are aligned with periodicity of PRS hop occasions (e.g., periodicity of the occasions for PRS hopping). As illustrated in FIG. 7B, one measurement gap may encompass one or more (e.g., all) hops in one occasion. If the WTRU is configured with one occasion which contains repetitions of frequency hopping patterns, the request may be a request to configure a measurement gap per PRS hop occasion (e.g., one measurement gap that encompasses all hops in one occasion as illustrated in FIG. 7B).

In some cases, the WTRU may be configured with periodic, semi-persistent, and/or aperiodic SRS frequency hopping transmission. The WTRU may receive configuration for periodic, semi-persistent and/or aperiodic SRS frequency hopping transmission (e.g., from a gNB). In periodic SRS frequency hopping, the WTRU may be configured with a periodicity of hop occasions. In semi-persistent SRS frequency hopping, the WTRU may receive an activation and/or deactivation command from the network via MAC-CE. Once semi-persistent SRS frequency hopping is activated, the WTRU may determine to transmit occasions of SRS frequency hops according to a configured frequency hopping pattern and periodicity. The WTRU may transmit the occasions of SRS frequency hops until the WTRU receives a deactivation command from the network. The WTRU may receive a trigger (e.g., via DCI) for an aperiodic SRS frequency hopping transmission. The trigger may indicate one or more occasions (e.g., burst) of SRS frequency hops. In some cases, the WTRU may transmit occasions of frequency hops over configured and/or dynamic grants configured by the network.

In some cases, the WTRU may be configured with on-demand PRS hopping. The WTRU may send a request to the network to request a specific parameter for PRS hopping. In examples, WTRU may send the request, via an LPP message, RRC, MAC-CE, and/or UCI. The WTRU may request any type of parameter as described herein. For example, the WTRU may send a request for any PRS hopping configuration. The WTRU may send a request to trigger PRS hopping from a desired TRP by indicating a TRP/PRS ID. In some cases, the WTRU may send a request to activate a PRS hopping pattern with a specific periodicity. The WTRU may send a request for a specific hopping pattern index.

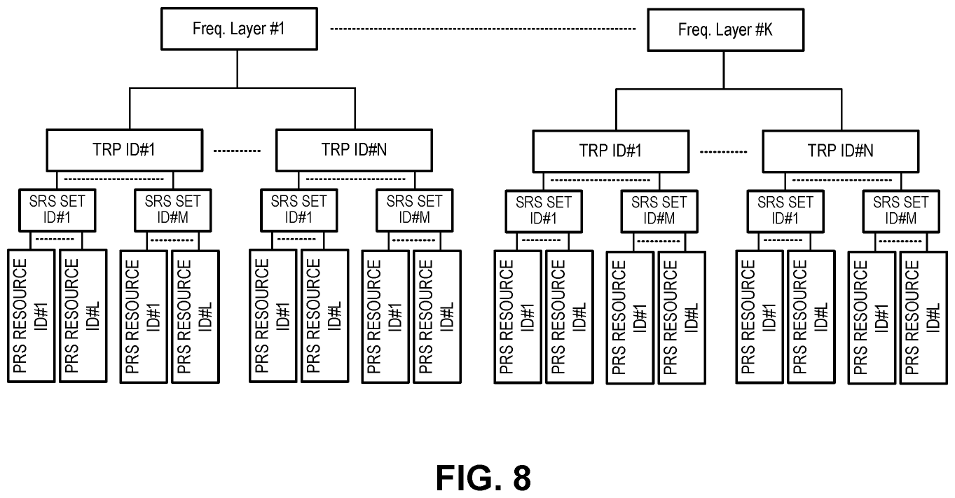

In some cases, the parameters for PRS hops in the PRS configuration may be configured in a hierarchy. As illustrated in FIG. 8, the parameters for PRS may be configured in a hierarchy. The hierarchy is also applicable to SRS parameters. In some examples, a parameter and/or value(s) of a parameter related to PRS/SRS hopping may be associated with an entity (e.g., a frequency layer, TRP, PRS resource set, etc.) in the hierarchy. The WTRU may determine that any entities at a lower hierarchy level than the associated entity are associated with the same parameter and/or value(s) of a parameter. Configurations for a PRS hopping pattern (e.g., hop gap, BW overlap) may be associated with existing PRS parameters (e.g., PRS ID). In some cases, PRS hops may be associated with a PRS resource. One or more configurations related to PRS hops (e.g., periodicity of occasion) may be associated with the PRS resource set associated with the PRS resource. In some cases, one or more configurations (e.g., a set of repetition factors) may be configurable for a PRS resource set such that PRS hops associated with the PRS resource set may be configured with the same set of repetition factors. In some cases, a periodicity for PRS transmission may be configured at the PRS resource set level such that PRS resources that belong to the set are configured with the same periodicity. By configuring parameters in a hierarchical manner, overhead for signaling may be reduced. As such, the WTRU may determine that the same set of parameters configured at a higher level in the hierarchy is applicable to the parameters at the lower level. The following are examples of configured parameters.

In examples, the frequency hopping patterns may be configured per frequency layer. The WTRU may determine that TRPs (e.g., identified by PRS IDs), PRS resource sets (e.g., identified by a resource set ID), and/or PRS resources associated with the frequency layer may be configured with at least one of the patterns from the same set of hopping patterns.

In examples, values of gap(s) between consecutive hops may be configured for each frequency layer. The values of gap(s) may be expressed in terms of symbols, slots, frames, or any time unit. The WTRU may determine that one of the values may be configured for the gap between each hop.

In examples, the number(s) of hops in a pattern may be configured per frequency layer. The WTRU may determine that the same set of number(s) may be configured to PRS resource(s) associated with the frequency layer.

In examples, a measurement type may be configured with the frequency layer. The measurement type may be one or more of: coherent combining, a per-hop pair based measurement, and/or a per hop based measurement. In coherent combining, the WTRU may perform measurements (e.g., RSRP, RSTD) on one or more (e.g., all) hops in a hop occasion and report one measurement (e.g., an average of the measurements). In a per-hop pair based measurement, the WTRU may receive hop pairing information from the network (e.g., hop #1 from TRP1 and hop #1 from TRP2). Further, the WTRU may perform a measurement (e.g., RSTD) based on the hop pair. Having performed the measurement, the WTRU may send a measurement report containing measurements per hop pair. Additionally, or alternatively, the WTRU may perform measurements (e.g., RSRP) per hop and report measurements per hop. the WTRU may determine to perform measurements according to the measurement type associated with the frequency layer that is associated with the PRS resource (e.g., if the WTRU is to determine a measurement type and can perform a measurement on PRS hops).

In examples, a frequency hopping pattern may be associated with the repetition factor that is configured per PRS resource set. If different PRS resource sets are configured with different repetition factors, the WTRU may determine that a different frequency hopping is associated with different PRS resource sets. The WTRU may be preconfigured with a mapping table that associates a repetition factor and PRS frequency hopping pattern.

Although PRS is used in the above examples, the examples may be applicable to any RS, such as SRS or SRS for positioning. Frequency hopping patterns may be configured per frequency layer. In some cases, the WTRU may determine that SRS resource sets (e.g., identified by resource set ID) or SRS resource associated with the frequency layer can be configured with at least one of the patterns from the same set of hopping patterns. If the WTRU is to determine a frequency hopping pattern for an SRS resource (e.g., to avoid collision with scheduled UL transmission), the WTRU may select one of the patterns associated with the frequency layer associated with the SRS resource.

Further, although transmission hopping is used as an example above, the above example is also applicable to Rx hopping. Rx hopping patterns may be configured per frequency layer. In some cases, if the WTRU is to determine an Rx hopping pattern for a PRS (e.g., identified by its PRS resource ID), the WTRU may determine to select one of Rx hopping patterns associated with the frequency layer to make measurement on the PRS. The WTRU may select the Rx hopping patterns associated with the frequency layer associated with the PRS in the hierarchy.

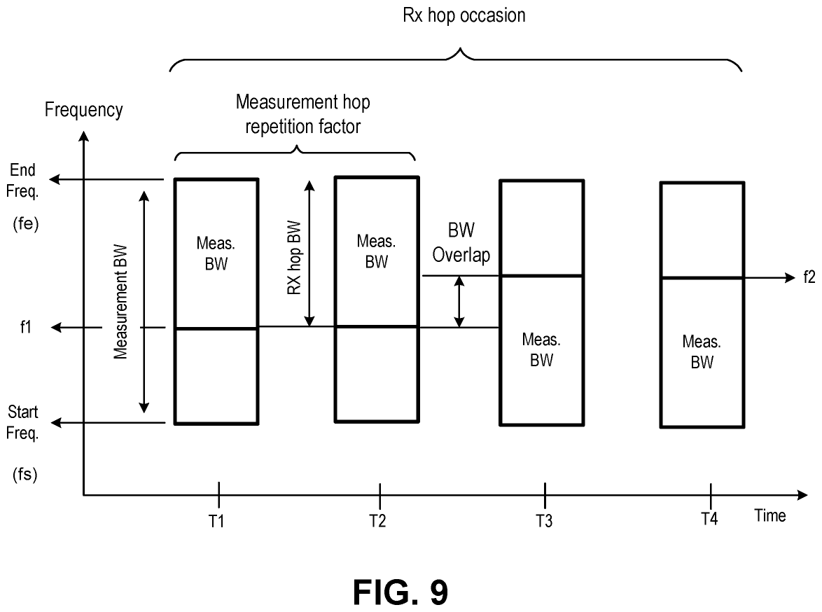

In some cases, the WTRU may be configured for Rx hopping with Rx hopping parameters. In Rx hopping, the WTRU may be configured to perform measurements on a configured bandwidth. The WTRU may receive configuration information for performing PRS measurements. The configured bandwidth may be indicated (e.g., in the configuration information) by a center frequency and/or a range of frequencies. FIG. 9 illustrates an example of Rx hopping. In Rx hopping, the WTRU may receive PRS from the network. The WTRU may be configured to measure a part or portion of the PRS bandwidth (e.g., as illustrated in FIG. 9). The WTRU may perform PRS measurements on the band from f1 to the end frequency (fe) at T1 and T2, timings at which the WTRU receives PRS from the network. The WTRU may perform measurements on PRS on the band from start frequency (fs) to f2. In some cases, (e.g., as illustrated by f1>f2 in FIG. 9) there may be an overlap in the measured bandwidth. However, the examples discussed herein are not limited to overlapped BW, and it should be understood that this example may be applicable to cases in which there are no overlaps between bandwidth of measurements made at consecutive timings. As discussed herein, the WTRU may report the PRS measurement and/or an indication that the measurement is based on multiple frequency hops.

In some cases, the WTRU may be configured with a measurement hop repetition factor. For example, the WTRU may be configured with a measurement hop repetition factor in which the WTRU is configured to measure the same range in the frequency domain at more than one received time instance. For example, the WTRU may be configured with N=2 where N is the measurement hop repetition factor. The Rx hopping pattern in this example may be represented by [(f1, fe), (fs, f2)] where each hop represents a range of frequency, indicated by lowest and highest frequency in the range and a pattern is a sequence of hops.

A measurement hop repetition factor may be applicable to each hop. The WTRU may receive a repetition factor (N) from the network. The WTRU may determine to measure the same frequency range N times. Alternatively, or additionally, the RX frequency hopping pattern may be represented by the differential between the start frequency of each hop and the reference frequency, assuming the same hop BW for one or more (e.g., all) hops.

In some cases, the WTRU may follow the pattern to perform measurements on different bands in the received PRS. The frequency range may be represented in terms of a frequency unit (e.g., Hz, RE ID number/number, and/or RB ID number/number).

A sequence of Rx hops may be referred to as an Rx hop occasion. In examples, the WTRU may perform measurements on several PRS transmissions over several Rx hop occasions. The WTRU may be configured (e.g., by the network) with a measurement time window during which the WTRU is expected to perform measurements. In some cases, the measurement time window may include more than one Rx hop occasion and/or partial Rx hop occasion. The WTRU may be configured with a start time, an end time, and/or a duration of the time window by the network. The duration may be expressed in time units (e.g., seconds, symbols, slots, frames, etc.). The start and/or end time may be expressed in terms of a time index (e.g., absolute time, symbol/slot/frame index, etc.).

In some cases, the WTRU may determine the bandwidth overlap for Rx hopping using a similar procedure that the WTRU uses to determine the bandwidth overlap for Tx hopping. The WTRU may determine the BW overlap based on the WTRU capability. For example, the WTRU may be configured to maintain phase consistency during a time window (e.g., N slots, M seconds) based on the capability of the WTRU. Based on the duration of the time window, the WTRU may determine the amount of BW overlap. The WTRU may be preconfigured with a mapping table that maps the BW overlap to the duration of the time window. For example, if the WTRU is configured to maintain phase continuity for 5 slots, the WTRU may determine that the BW overlap should be 1 RB. In another example, if the WTRU is configured to maintain phase continuity for 10 slots, the WTRU may determine that the BW overlap is 2 RBs.

In some cases, the WTRU may determine Rx hop BW for RX hopping based on channel conditions and/or PRS configurations. For example, the WTRU may be preconfigured with a mapping table that associates the number of paths in the channel to Rx hop BW. Rx hop BW may be reduced if the number of paths is large to avoid inaccurate measurements due to frequency selectivity. The WTRU may be configured with a threshold in which the WTRU can determine to select a preconfigured Rx hop BW. In some cases, the WTRU may be configured with the threshold in which the WTRU can determine to select the preconfigured Rx hop BW, if the number of paths is larger than the threshold. In some cases, the WTRU may be preconfigured with a mapping table that associates range(s) of Doppler shift/frequency to Rx hop BW(s). For example, the mapping table may associate 10 Hz<fd<100 Hz with 2 RBs for Rx hop BW. The WTRU may determine the Rx hop BW based on the observed Doppler shift/frequency and mapping table.

In some cases, the WTRU may determine an Rx hopping pattern based on PRS configurations. For example, the WTRU may be configured with a mapping table that associates a PRS configuration parameter (e.g., repetition factor) and a PRS hopping pattern. Based on the mapping table, the WTRU may determine the Rx hopping pattern to use during measurements. In one or more cases, the WTRU may use the Rx hopping pattern to perform measurements on PRS hops or normal PRS.

In some cases, the WTRU may be configured to use Rx hopping parameter(s) regardless of whether PRS hopping is enabled or not.

In some cases, the WTRU may determine that the PRS hopping pattern configured by the network is used for Rx hopping. The WTRU may receive a list of Rx hopping patterns that may be used when PRS hopping is enabled or disabled by the network. For example, the network may determine that PRS hopping is not enabled for a given cell. In such cases, the WTRU may determine to measure the frequency range(s) indicated by the Rx hop pattern while the network (e.g., TRP) transmits the normal PRS.

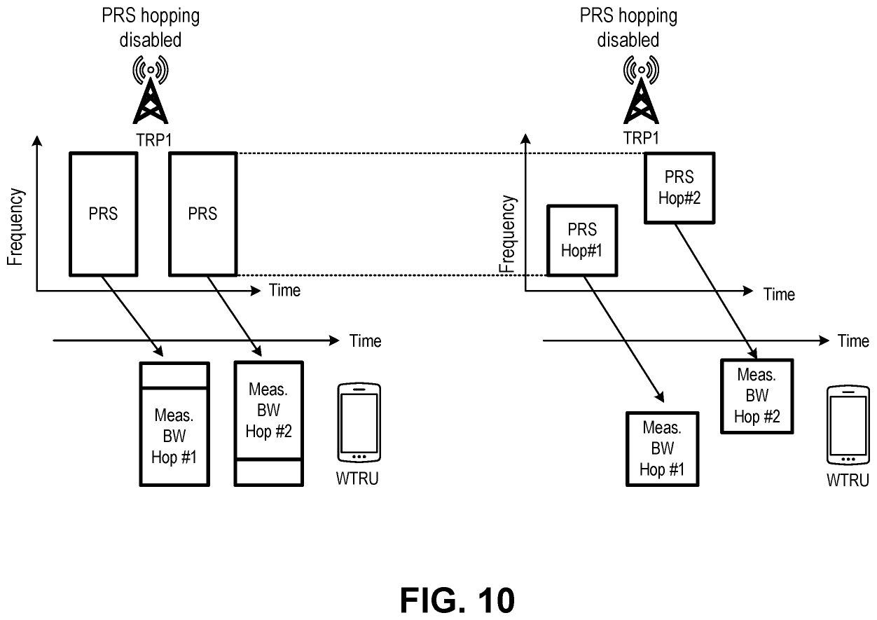

FIG. 10 illustrates an example in which the WTRU measures received normal PRS when the network does not enable PRS hopping. The WTRU may perform measurements on normal PRS according to the determined Rx hopping pattern. The WTRU may perform measurements according to the determined Rx hopping pattern (e.g., PRS hopping is enabled by the network). In some cases, the determined Rx hopping pattern may be the same hopping pattern used to perform measurements on the normal PRS. In some cases, as the network enables a PRS hopping pattern, the WTRU may use the Rx hopping pattern that matches the enabled PRS hopping pattern.

In some cases, the WTRU may determine a list of Rx hopping patterns that are applicable to a group of cells. For example, the WTRU may determine the list of Rx hopping patterns from a broadcast.

In some cases, the WTRU may determine that PRS hops and/or normal PRS are transmitted based on at least one of the following. The WTRU may determine that PRS hops and/or normal PRS are transmitted based on the WTRU receiving an indication from the network that PRS hops or normal PRS is transmitted from the network (e.g., TRPs). The WTRU may determine that PRS hops and/or normal PRS are transmitted based on the WTRU receiving, from the network, a mapping table that maps PRS hopping pattern to a parameter (e.g., PRS configuration parameter, index, etc.). The WTRU may determine that PRS hops and/or normal PRS are transmitted based on the WTRU receiving, from the network, a mapping table that maps Rx hopping pattern to a parameter (e.g., PRS configuration parameter, index, and the like). The WTRU may determine that PRS hops and/or normal PRS are transmitted based on the WTRU receiving configurations related to PRS hopping from the network. The WTRU may determine that PRS hops and/or normal PRS are transmitted based on the WTRU receiving configuration related to Rx hopping from the network. The WTRU may determine that PRS hops and/or normal PRS are transmitted based on the WTRU not receiving configurations for PRS hopping, but receiving configurations for hopping patterns (e.g., use the configured hopping pattern as Rx hopping pattern). Additionally, or alternatively, the WTRU may determine that PRS hops and/or normal PRS are transmitted based on the WTRU not receiving configurations for Rx hopping, but receiving configurations for hopping patterns (e.g., use the configured hopping pattern to receive PRS hops).

Based on whether the normal PRS or PRS hops are transmitted, the WTRU may determine to send a measurement report based on the transmission scheme. For example, if the normal PRS is transmitted from the network, the WTRU may determine to perform Rx hopping, perform measurements by combining measurements made per Rx hop (e.g., coherently combined RSRP, RSTD) and/or report the combined measurement to the network. In another example, if PRS hops are transmitted from the network, the WTRU may determine to perform one or more measurements per hop (e.g., RSRP per hop, ToA per hop) and report the measurements per hop to the network.

In some cases, the WTRU may send a request and/or capability information to the network. The request may be a request to transmit PRS hops and/or normal PRS. The capability information may indicate that the WTRU is capable of Rx hopping and/or capable of measuring PRS hops. In some cases, the WTRU may receive a default measurement range from the network. The default measurement range may be indicated by the lowest frequency and/or the highest frequency. If the WTRU is not configured with a hopping pattern (e.g., PRS hopping pattern, Rx hopping pattern), the WTRU may determine to perform measurements on the received PRS on the configured default measurement range.

In some cases, the WTRU may be configured to determine a hopping pattern based on one or more PRS configurations. For example, the WTRU may be configured to send the WTRU capability to the network. The WTRU may be configured to receive one or more PRS configurations (e.g., a repetition factor, bandwidth, etc.) from the network. In some cases, WTRU may be configured to receive the one or more PRS configurations from the network (e.g., LMF, gNB, etc.). The WTRU may be configured to receive a mapping table that associates repetition factor(s) and hopping pattern(s) from the network. The WTRU may be configured to receive a configuration for a measurement gap from the network. The WTRU may be configured to determine the Rx frequency hopping pattern based on the configured repetition factor and mapping table. The WTRU may be configured to perform measurements (e.g., RSRP) on the received PRS during the configured measurement gap based on the determined frequency hopping pattern. the WTRU may be configured to coherently combine the measurements (e.g., find average RSRP) and send the measurement to the network (e.g., if the WTRU does not receive configurations for PRS hopping patterns from the network). The WTRU may be configured to report RSRP per hop to the network (e.g., if the WTRU receives configurations for PRS hopping patterns from the network).

In some cases, the WTRU may be configured to indicate any changes at the WTRU during measurement. For example, the WTRU may be configured to indicate changes that correspond to spatial consistency, phase maintenance, etc. In some cases, the WTRU may determine to indicate any changes during the measurement. For example, if the WTRU determines to perform measurements based on an Rx hopping pattern, the WTRU may indicate to the network if at least one of the following has changed during the measurement: spatial consistency, phase consistency, and/or differentials above a threshold.

With respect to spatial consistency, the WTRU may be configured to determine to use a different antenna, change hardware (e.g., amplifier, filter), and/or change direction of the receiving antenna during the measurement during an Rx hop occasion/measurement time window. The WTRU may send an indicator and/or include the indicator in the measurement report. The indicator may be associated with more than one measurement. The indicator may indicate whether the spatial consistency is maintained measurements made on Rx hops or Rx antenna/port index (or indices) used during the measurement. In examples, the indicator may indicate whether the spatial consistency is maintained by providing a 1 for a maintained spatial consistency or a 0 for a changed spatial consistency. In some cases, the WTRU may indicate that the measurements made on Rx hops belong to the same group by indicating a group index. The measurements that belong to the same group may indicate to the network that spatial consistency is maintained in the measurements.

The WTRU may be configured to indicate whether phase consistency is maintained during the measurement. During the measurement, the WTRU may change hardware for receivers (e.g., amplifier, filter, etc.) that may break phase consistency in measurement and introduce phase offset and/or drift to the measurement unknown to the network. The WTRU may indicate phase is consistent for the measurements made on Rx hops. The WTRU may send an indicator and/or include the indicator in the measurement report. The indicator may be associated with one or more than one measurement. In some cases, the WTRU may indicate that the measurements made on Rx hops belong to the same group by indicating a group index. The measurements which belong to the same group may indicate to the network that phase consistency is maintained in the measurements.

With respect to differentials above a threshold, the WTRU may be configured to determine to include the aforementioned indicators if one or more of the phase, power, time difference, and/or drift in the measurement is above or below a preconfigured threshold. In some cases, the network may configure the threshold.

In some cases, a PRS configuration may contain one or more of the following parameters: a number of symbols, a transmission power, a number of PRS resources included in PRS resource set, a muting pattern for PRS, periodicity, a type of PRS (e.g., periodic, semi-persistent, or aperiodic), a slot offset for periodic transmission for PRS, a vertical shift of PRS pattern in the frequency domain, a time gap during repetition, a repetition factor, a resource element (RE) offset, a comb pattern, a comb size, a spatial relation, QCL information for PRS, a number of PRUs, a number of TRPs, an Absolute Radio-Frequency Channel Number (ARFCN), a subcarrier spacing, an expected RSTD, an uncertainty in expected RSTD, a start Physical Resource Block (PRB), a bandwidth, a BWP ID, a number of frequency layers, a start/end time for PRS transmission, an on/off indicator for PRS, a TRP ID, a PRS ID, a cell ID, a global cell ID, a PRU ID, and/or an applicable time window. The muting pattern may be expressed, for example, via a bitmap. QCL information may include, for example, a QCL target, QCL source, etc. In some cases, the WTRU may apply a PRS configuration under a condition that the current time is within the applicable time window.

In some cases, SRS for positioning (SRSp) or SRS configuration may include one or more of: a resource ID, comb offset values, cyclic shift values, a start position in the frequency domain, a number of SRSp symbols, a shift in the frequency domain for SRSp, a frequency hopping pattern, a type of SRSp (e.g., aperiodic, semi-persistent or periodic), a sequence ID used to generate SRSp, other IDs used to generate SRSp sequence, a spatial relation information that indicates which reference signal or SSB the SRSp is related to spatially where the SRSp and DL RS may be aligned spatially, QCL information, QCL type, a resource set ID, a list of SRSp resources in the resource set, a transmission power related information, a pathloss reference information, a periodicity of SRSp transmission, spatial information such as spatial direction information of SRSp transmission (e.g., beam information, angles of transmission), and/or spatial direction information of DL RS reception (e.g., beam ID used to receive DL RS, angle of arrival). In some cases, the reference signals indicated by the spatial relation information may include one or more of: DL RS, UL RS, CSI-RS, SRS, and/or DM-RS. The SSB indicated by the spatial relation information may include one or more of: SSB ID, and/or cell ID of the SSB. QCL information may include a QCL relationship between SRSp and/or other reference signals or SSB. A QCL type may be, in examples, QCL type A, QCL type B, and/or QCL type D. In some cases, pathloss reference information may include an index for SSB, CSI-RS and/or PRS.

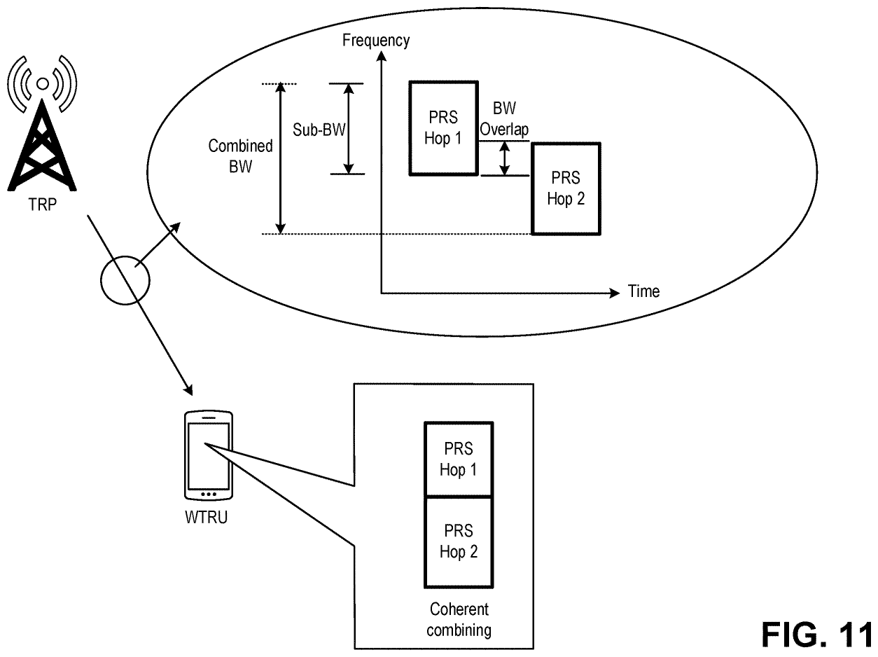

As illustrated in FIG. 11, the WTRU may accumulate measurements made on PRS hops (e.g., RSRP, RSTD) and perform combining (e.g., averaging). Alternatively, or additionally, the WTRU may accumulate measurements made from each hop in the buffer. The WTRU may perform phase correction between hops (e.g., if there are any phase drifts between consecutive hops in the time domain). The WTRU may transform the phase drifts between the consecutive hops into the frequency domain via fast Fourier Transform and/or discrete Fourier Transform (FFT/DFT). The WTRU may perform measurements in the frequency domain.

In NLOS heavy environments, RSRP may drop significantly and the WTRU may not be able to perform measurements on PRS, or the network may not successfully receive SRS transmitted by the WTRU. As such, the WTRU may be configured to perform measurements adaptively, such that even in a challenging environment, the WTRU may obtain timing/power measurements.

Implementing the embodiments discussed herein may improve accuracy in positioning. Further, implementing the embodiments discussed herein may reduce the likelihood of increased latency during positioning in the environment in which PRS and/or SRS is received/transmitted at lower priority compared to other channels. In addition, the embodiments discussed herein may improve accuracy and reduce latency required for positioning in the presence of multipath channels/NLOS in which the quality of reception of reference signals degrade. In some cases, the embodiments discussed herein may be beneficial for WTRUs with limited capabilities (e.g., those WTRUs that are able to transmit over a small bandwidth or make measurements over a small bandwidth).

In some cases, the WTRU may be configured for adaptive selection of a frequency hopping pattern (e.g., to avoid collision with UL channel transmission). The WTRU may be configured to select a hopping pattern that does not collide with a configured UL transmission. In examples, the WTRU may receive configurations for SRSp from the network via RRC or LPP message from the network (e.g., LMF, gNB). In addition, the WTRU may receive configurations for hopping configurations (e.g., hop gap, frequency hopping bandwidth, hop periodicity).

In some cases, the WTRU may receive an activation command from the network for a frequency hopping. Alternatively, or additionally, the WTRU may receive a higher-layer message (e.g., RRC, LPP message) from the network indicating start/end time for frequency hopping. The WTRU may determine hop occasions for frequency hopping based on one or more of a configured grant; a dynamic grant; a start time, an end time, a duration of a hop window, and/or a periodicity of hop occasions.

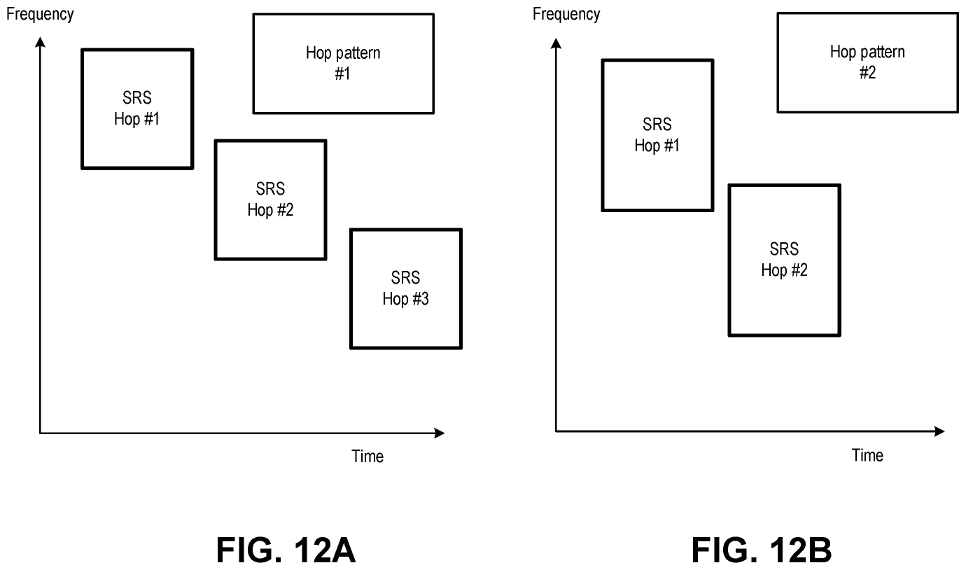

In some cases, the WTRU may be configured with more than one frequency hopping patterns from the network via higher layer signals (e.g., via an RRC message, LPP message, etc.). The WTRU may receive hopping configurations (e.g., hop BW, hop gap) for each frequency hopping pattern. Each frequency hopping pattern may be associated with a hop ID. FIG. 12A and FIG. 12B illustrate examples of frequency hop patterns. For example, as illustrated in FIG. 12A and FIG. 12B, hop patterns #1 and #2 have 3 hops and 2 hops, respectively, that cover the same frequency hopping bandwidth.

In some cases, the WTRU may receive a request from the network to transmit uplink channel (e.g., PUCCH/PUSCH). Alternatively, or additionally, the WTRU may determine to transmit uplink channel to send a scheduling request, PUSCH by configured grant, and/or ACK/NACK to the network. In some cases, the network or WTRU may determine to choose a different pattern for SRS frequency hops to avoid the collision based on the high-priority content of the uplink channel. The WTRU may receive a configuration/indication for uplink channel transmission from the network. For example, the WTRU may receive a DCI that indicates a request for an uplink channel (e.g., PUSCH, PUCCH) transmission. The WTRU may determine to transmit on the uplink channel. In some cases, the configured/scheduled uplink channel transmission may collide with at least one of the SRS hops in a hop occasion in time and/or frequency domain. In some cases, if the WTRU may determine or receive (e.g., from the network) one or more of an indication, configuration, and/or a schedule. This may occur (e.g., N symbols/slots/frames) earlier than a preconfigured time before an initial transmission time, the initial transmission time may be at least one of the following: a first symbol of the first symbol of the first hop in an occasion; or the first symbol of the occasion (e.g., in case there is a time offset in the occasion). When the initial transmission time is the first symbol of the occasion, the WTRU may determine to select a frequency hopping pattern which avoids the collision.

In some cases, the preconfigured time may be a preparation time for the WTRU to prepare transmission of SRS frequency hops. In some cases, if the WTRU determines or receives, from the network, one or more of an indication, configuration, and/or schedule (e.g., N symbols/slots/frames) later than a preconfigured time, the WTRU may determine to transmit the SRS frequency hops instead of the indicated/configured/scheduled UL channel (e.g., PUSCH/PUCCH) transmission. Examples of frequency hopping patterns are illustrated in FIG. 12A and FIG. 12B in which two frequency hopping patterns are illustrated and each pattern is identified by an ID number.

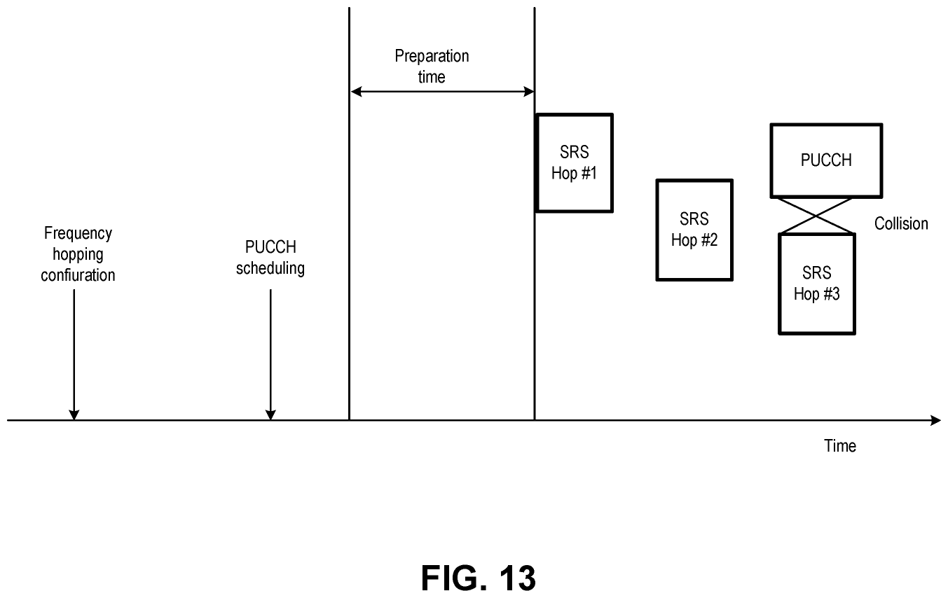

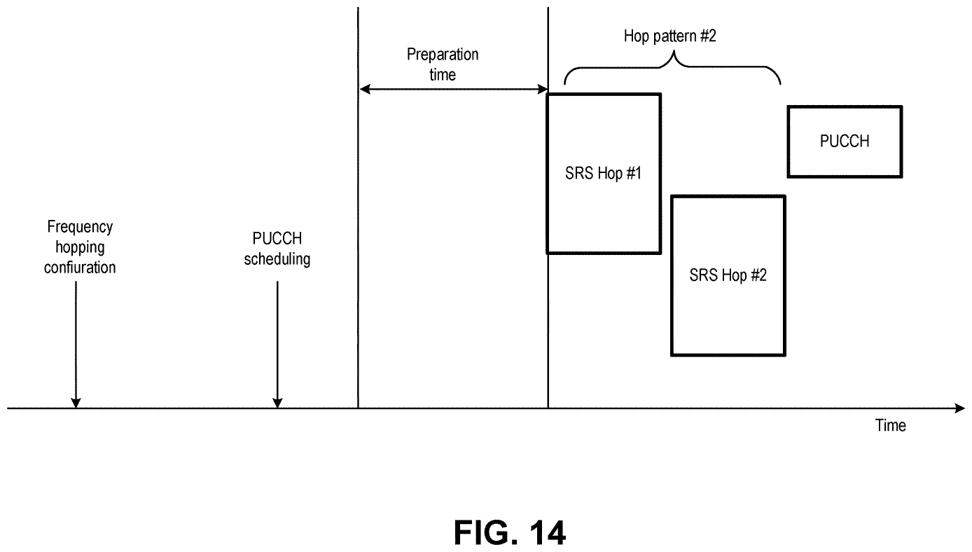

In some cases, the WTRU may be configured with a timeline requirement to select a frequency hopping pattern to avoid collision. An example of collision between an uplink channel and one of the hops in the SRS frequency hopping transmission is illustrated in FIG. 13 in which a PUCCH scheduled by the network collides with the third hop in the scheduled transmission of SRS frequency hops. In some cases, the WTRU may determine to select a frequency hopping pattern to avoid the collision if at least one of the timeline requirements is met. For example, since the scheduling indicator from the network (e.g., DCI) is received earlier than the preparation time for the SRS frequency hop transmission, the WTRU may determine to select the frequency hopping pattern such that the collision can be avoided. The subsequent WTRU behavior is illustrated in FIG. 14, such that the WTRU is configured to choose the second frequency hopping pattern that avoids collision with the scheduled PUCCH.

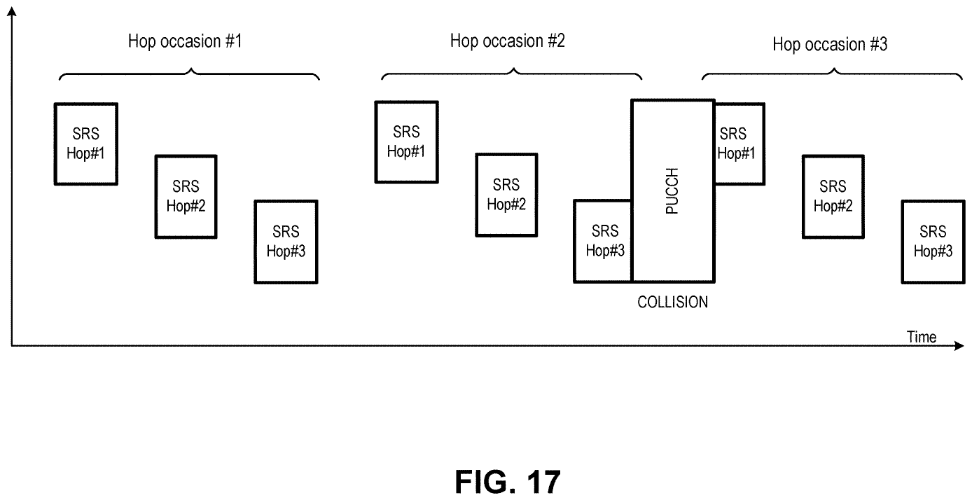

FIG. 17 illustrates an example of exchanges of signals between the network and WTRU. In some cases, the WTRU may receive a list of frequency hopping patterns from the LMF. The WTRU may receive an activation command (e.g., via MAC-CE) from the gNB. The WTRU may receive a scheduling indication from the gNB (e.g., PUCCH scheduling). In some cases, the WTRU may determine whether activated transmission of SRS frequency hops and PUCCH collide. For the cases in which the WTRU determines the collision, the WTRU may select an SRS frequency hopping pattern that avoids the collision. In some cases, the WTRU indicates a pattern ID to the LMF. In some cases, the WTRU may subsequently transmit SRS and scheduled PUCCH to the network.

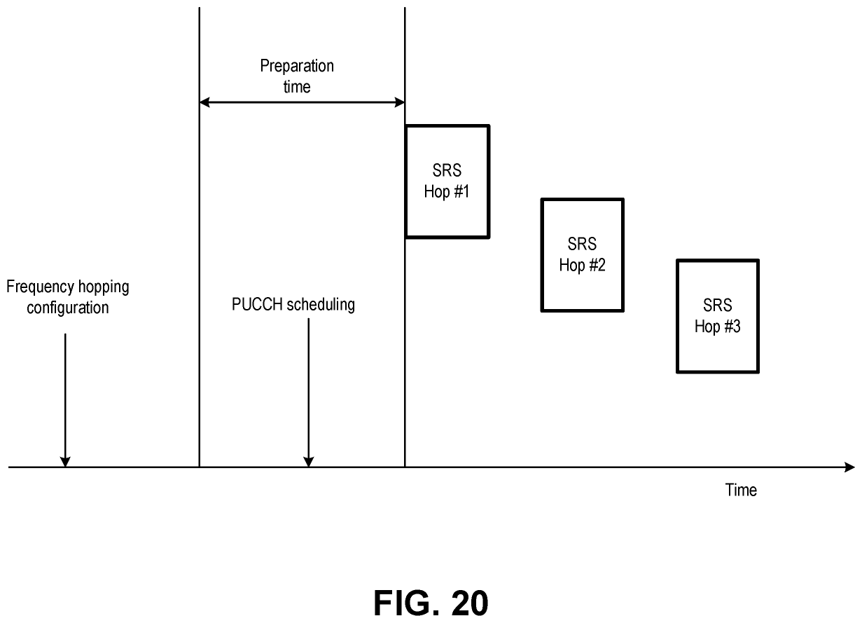

In some cases, the WTRU may detect a collision later than the preparation time (e.g., as illustrated in FIG. 14). The WTRU may determine a collision from the PUCCH scheduling indicator received from the network later than the preparation time. In such a case, it may be too late for the WTRU to prepare a new hopping pattern for transmission, and the WTRU may determine to ignore the PUCCH transmission schedule and transmit SRS frequency hops (e.g., as illustrated in FIG. 20).

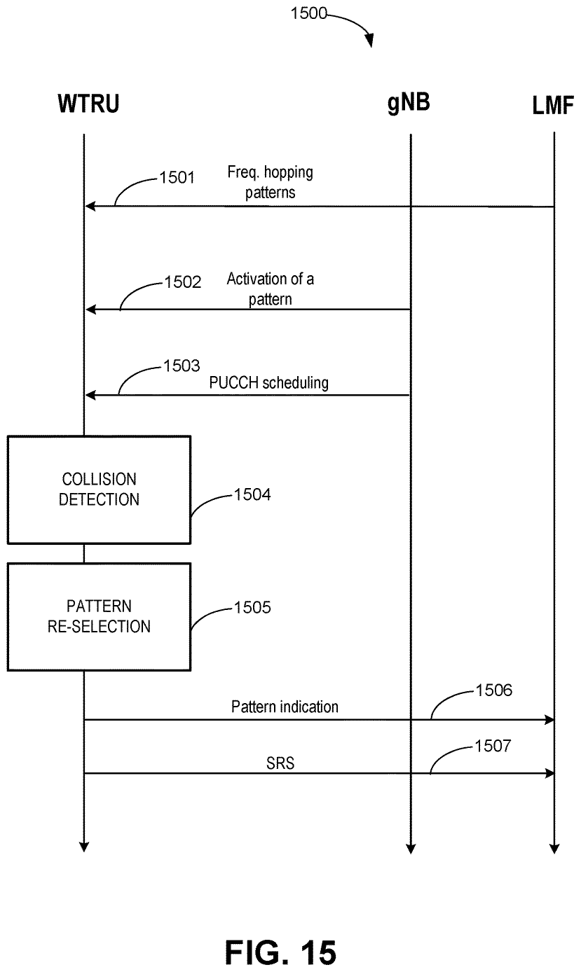

FIG. 15 shows an example of exchanges of signals between a network (e.g., including an LMF and a gNB) and a WTRU at 1500. At 1501, the LMF may send one or more frequency hopping patterns to the WTRU. At 1502, the gNB may send a message indicating activation of a pattern to the WTRU. At 1503, the gNB may send a message comprising PUCCH scheduling to the WTRU. At 1504, the WTRU may perform collision detection. At 1505, the WTRU may perform pattern re-selection. At 1506, the WTRU may send a message to the LMF including a pattern indication. At 1507, the WTRU may send an SRS to the LMF.

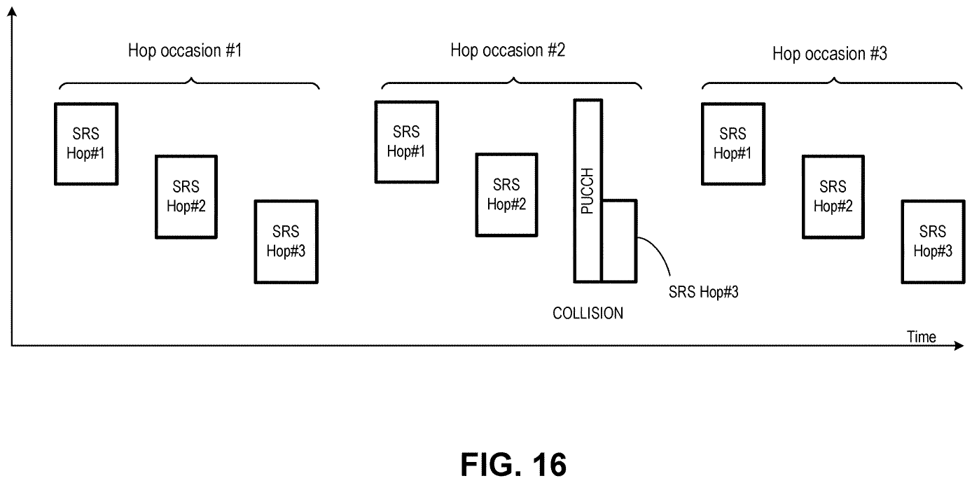

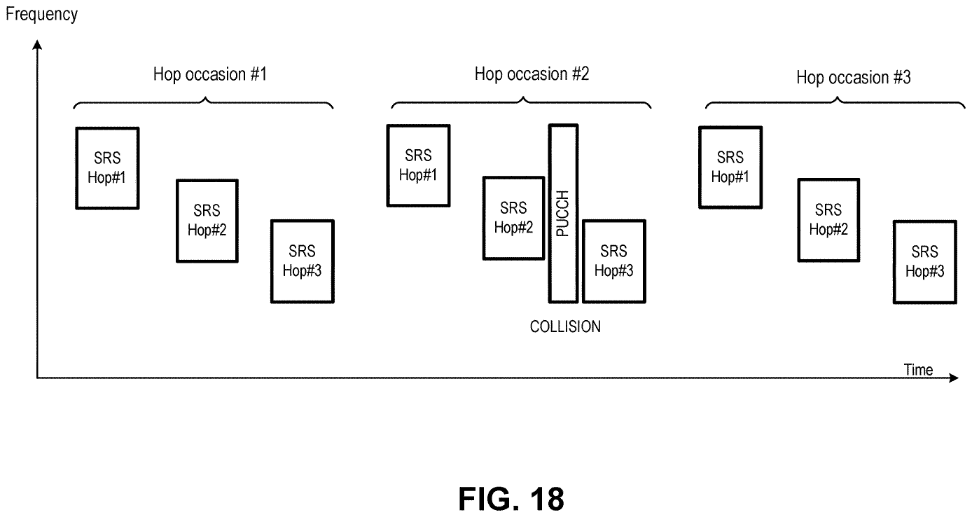

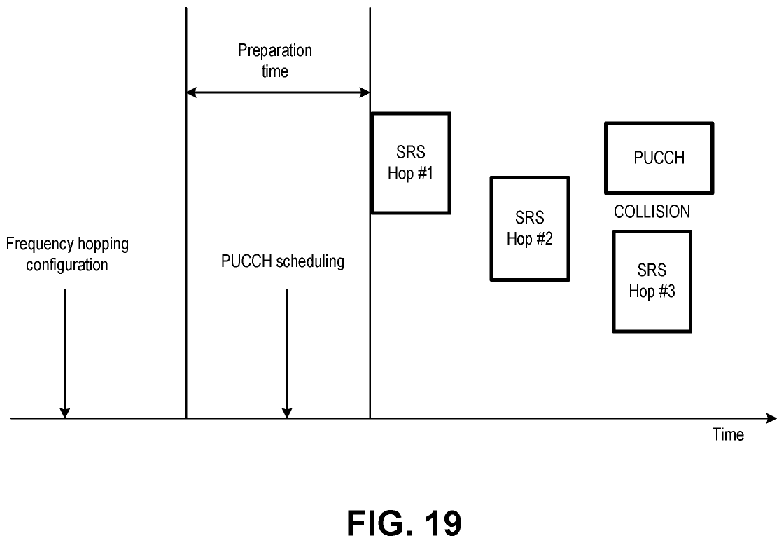

A collision between SRS frequency hops and uplink channel may be defined according to one or more of the following: time and/or frequency resources of a scheduled uplink channel; an uplink channel transmission scheduled between hops; and/or an uplink channel scheduled during transmission preparation time of SRS. In some cases, time and/or frequency resources of a scheduled uplink channel (e.g., PUCCH/PUSCH) may overlap with time and/or frequency resources of at least one of the SRS frequency hops. FIG. 16 illustrates an example of an overlap of time and frequency resources with a scheduled uplink transmission and an SRS frequency hop. As illustrated in FIG. 16 the scheduled PUCCH transmission may collide with one of the hops (e.g., hop #3) in the hop occasion #2. FIG. 17 illustrates another example of an overlap of time and frequency resources with scheduled uplink transmissions and SRS frequency hops. As illustrated in FIG. 17, a collision between PUCCH and SRS frequency hops may occur over more than one hop occasion, such as hop occasion #2 and hop occasion #3. In some cases, as illustrated in FIG. 18, an uplink channel transmission may be scheduled between hops. For example, as illustrated in FIG. 18, there may be no overlap between time/frequency resources of scheduled uplink transmission and SRS transmission hops. In such cases, a PUCCH transmission may be scheduled between SRS frequency hops. In some cases, the uplink channel may be scheduled during the transmission preparation time of SRS. For example, for the cases in which the WTRU determines that uplink channel transmission is scheduled during the transmission preparation time (e.g., illustrated as “preparation time” in FIG. 13 and FIG. 14) the WTRU may determine that there is a collision between occasions of SRS scheduled for transmission and the uplink channel. FIG. 19 shows an example of collision detection during preparation time.

If the WTRU detects a collision later than the preparation time, the WTRU may prioritize a PUCCH transmission over transmission of SRS frequency hops based on one or more of the following: content of a PUCCH or PUSCH, a priority level associated with the uplink channel, a relative difference of a priority level between SRS and an uplink channel, and/or a scheduled time for transmission of PUCCH with respect to the time the WTRU receives the transmission request. In some cases, the content of the PUCCH may be for example, ACK/NACK, SR, etc. In some cases, the content of the PUSCH may be, for example, a CSI report. In some cases, the priority level associated with the uplink channel may be for example, a high/medium level of priority for PUCCH. In some cases, the relative difference of the priority level between SRS and the uplink channel may be, for example, a priority level of SRS lower than that of PUCCH.

In some cases, the WTRU may be configured to determine a UL hopping pattern to avoid a collision. In some cases, the WTRU may receive SRSp configurations, hopping configurations and/or a list of SRS hopping patterns from the network. Each pattern may be associated with an ID (e.g., an index). In some cases, the WTRU may receive the SRSp configurations and/or hopping configurations (e.g., a duration of a hop and/or periodicity of hopping occasion). In some cases, the WTRU may receive the SRSp configurations, hopping configurations, and/or a list of SRS hopping patterns from the network (e.g., from an LMF, a gNB, etc.). In examples, a hopping pattern may include a set of two or more hops per hopping occasion. A hopping occasion may correspond to a time unit (e.g., symbol or slot) or time span of multiple time units. In examples, a first hop in a hopping occasion may correspond to a first set of frequency resources and a second hop in a hopping occasion may correspond to a second set of frequency resources. The second set of frequency resources may overlap or not overlap with the first set of frequency resources but is not the same as the first set of frequency resources.

In some cases, the WTRU may receive a configuration or indication indicating a frequency hopping pattern (e.g., an SRS hopping pattern) from the list. In examples, the configuration or indication may be a pattern ID to use for transmission. In some cases, the WTRU may receive a UL channel transmission request (e.g., PUCCH/PUSCH) from the network (NW) (e.g., from an LMF, gNB).

If the WTRU determines a collision would occur between the UL channel transmission and an SRS frequency hop in a hopping occasion of the indicated hopping pattern, and the determination or the receipt of the UL channel request is before (e.g., at least a preconfigured time such as N symbols or slots before) the first hop in the hopping pattern in the hopping occasion, the WTRU may select another SRS hopping pattern that avoids the collision with the uplink transmission. In some cases, if there is more than one frequency hopping patterns that avoids the collision, the WTRU may select the pattern with smallest number ID. The WTRU may indicate the selected ID to the network (e.g., via one or more of a UCI, MAC-CE, RRC and/or LPP message). In some cases, the WTRU may transmit SRS using frequency hops according to the selected frequency hopping pattern. In some cases, if the WTRU is configured with periodic or semi-persistent SRS frequency hopping, the WTRU may continue to use the selected frequency hopping pattern. If the WTRU cannot find any pattern that avoids the collision, the WTRU may continue to use the indicated hopping pattern but not transmit one or more SRSs in the hopping occasion. For example, if the WTRU cannot find any pattern that avoids the collision, the WTRU may not transmit the colliding SRS hop(s) or one or more (e.g., all) of the SRS hops in the hopping occasion. The WTRU may transmit the scheduled uplink transmission.

In some cases, if the collision determination or UL channel request is not received before the first hop in the hopping pattern in the hopping occasion, the WTRU may continue to use the indicated SRS hopping pattern and may not transmit one or more hops (e.g., the WTRU may not transmit the colliding SRS hops). In some cases, the WTRU may continue to use the indicated SRS hopping pattern if the collision determination or UL channel request is not received at least the preconfigured amount of time before the first hop in the hopping pattern in the hopping occasion.

In some cases, the WTRU may be configured to select a frequency hopping pattern and determine a cancellation of a transmission. In some cases, the WTRU may be configured to cancel all hops. In some cases, the WTRU may determine to cancel and/or release an SRS hopping transmission if one or combination of the following conditions are met. In examples, the WTRU may determine to cancel/release the SRS hopping transmission if the WTRU is not configured with more than one frequency hopping patterns. The WTRU may not have any alternate frequency hopping pattern(s) to use in case of a collision. In examples, the WTRU may determine to cancel and/or release the SRS hopping transmission if the timeline requirement for the WTRU to select a frequency hopping pattern to avoid the collision is met. For example, the WTRU may determine to cancel/release the SRS hopping transmission if a scheduling indicator for uplink transmission is earlier than the configured time. In examples, the WTRU may determine to cancel/release the SRS hopping transmission if a collision occurs periodically and/or semi-persistently. A collision may occur periodically during a time interval. In examples, the WTRU may determine to cancel and/or release the SRS hopping transmission if a priority level of the scheduled uplink transmission is higher than a threshold configured by the network. In examples, the WTRU may determine to cancel and/or release the SRS hopping transmission if a preparation time for the scheduled uplink transmission is higher than a threshold configured by the network. In examples, the WTRU may determine to cancel and/or release the SRS hopping transmission if the WTRU receives a cancellation indicator from the network (e.g., via a DCI, MAC-CE, RRC, etc.) to cancel transmission of SRS transmission hops. The cancellation indicator from the network may indicate to the WTRU to cancel one or more of the following: one or more occasion of the scheduled SRS transmission, part of the scheduled occasions of SRS transmission(s), or all of scheduled occasions of SRS transmission(s).

In some cases, if the WTRU is not configured with more than one frequency hopping patterns and PUCCH scheduling is received earlier than the preparation time (e.g., as illustrated in FIG. 14) the WTRU may determine to cancel the transmission of SRS frequency hops and transmit PUCCH instead. In some cases, if the PUCCH scheduling is received during the preparation time, and the WTRU is not configured with more than one frequency hopping pattern, the WTRU may determine to ignore scheduling of PUCCH transmission and transmit SRS frequency hops.

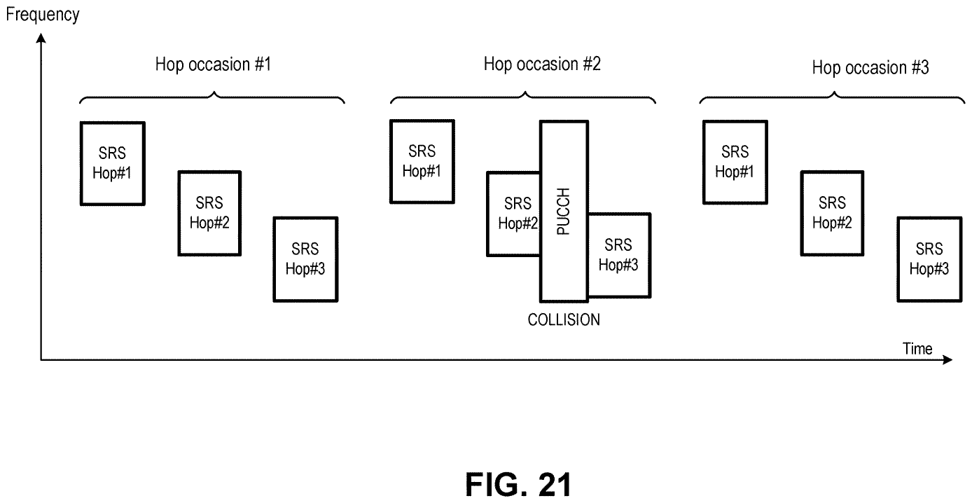

In some cases, if the WTRU is configured with periodic transmission of SRS frequency hops, the WTRU may determine to cancel the occasion of hops. FIG. 21 illustrates an example periodic transmission of SRS hop and a collision with an uplink channel. In examples, the WTRU may determine that a collision occurs with PUCCH and one or more hops (e.g., SRS Hop #2 and SRS Hop #3) from SRS frequency hops during the hop occasion #2. As such, if the WTRU determines to cancel transmission of hop occasion #2, the WTRU may cancel the transmission of SRS frequency hops at occasion #2 (e.g., only at occasion 2) and transmit the SRS frequency hops at occasion #1 and #3.

In some cases, the WTRU may determine that the collision occurs at more than one occasion. For example, the scheduled PUCCH transmission may overlap with more than one frequency hops over consecutive occasions (e.g., as illustrated in FIG. 17). Alternatively, or additionally, a periodic uplink channel transmission may overlap with one or more periodic and/or semi-persistent occasions of a transmission of SRS frequency hops. A collision may occur periodically. If an uplink channel transmission and/or a transmission of SRS frequency hops are scheduled semi-persistently (e.g., periodically during a configured window), the collision may occur periodically during a time interval. If the WTRU determines that the collision occurs at more than one occasion, the WTRU may determine to cancel transmission of SRS frequency hops at one or more (e.g., all) occasions in which the collision occurs. If the timeline requirement discussed herein is satisfied, the WTRU may determine to select a frequency hopping pattern that avoids the collision.

In some cases, the WTRU may receive a cancellation indicator from the network to cancel a transmission of SRS transmission hops. Similar to the timeline requirement, if the WTRU receives the cancellation indicator earlier than the preconfigured time (e.g., N symbols/slots/frames from transmission of the first hop in an occasion), then the WTRU may determine to cancel one or more (e.g., all) transmissions of SRS frequency hops after one or more of the following. The WTRU may determine to cancel one or more (e.g., all) transmissions of SRS frequency hops for all occasions of transmission of SRS frequency hops that occur after the WTRU received the cancellation indicator. The WTRU may determine to cancel one or more (e.g., all) transmissions of SRS frequency hops for all occasions of transmission of SRS frequency hops after the time indicated in the indicator (e.g., M slots/symbols/frames after the WTRU received the indicator, absolute time).

In some cases, the WTRU may be configured with a cancellation period with a duration (e.g., N slots). The duration may be a function of the gap between hops in the pattern. The period for the duration may start before transmission of the first hop. In some cases, if the WTRU receives a cancellation indication from the network for frequency hopping before the cancellation period, the WTRU may determine to cancel one or more (e.g., all) of the hops associated with the window, including the first hop. In some cases, if the WTRU receives a cancellation indication within the period, the WTRU may determine to cancel any hops that are outside of the new cancellation period. In some cases, the WTRU may determine to cancel one or more hops that are outside of the new cancellation period starting from the time the WTRU receives the cancellation indication.

In some cases, the WTRU may be configured with fallback behavior during a collision for UL transmissions. In some cases, the WTRU may receive one or both of SRSp configurations and hopping configurations. The hopping configurations may be, for example, a duration of a hop, a periodicity of occasion, etc. In some cases, if the WTRU is preconfigured with a list of SRS hopping patterns from the NW (e.g., LMF, gNB) in which each pattern is associated with an ID between UL channel transmission and SRS, the WTRU may receive configurations for transmission of frequency hops. The configurations for transmission of frequency hops may be, for example, the pattern ID to use for transmission. In some cases, the WTRU may receive UL channel transmission request (e.g., PUCCH/PUSCH) from the NW (e.g., LMF, gNB).

In some cases, the WTRU may detect a collision between UL channel transmission and one of the SRS frequency hops earlier than preconfigured time (e.g., N slots) before the first transmission of the first SRS transmission in the hop. If the WTRU is preconfigured with a list of SRS frequency hopping patterns from the NW, the WTRU may determine to select an SRS hopping pattern that avoids the collision with the uplink transmission. If more than one frequency hopping patterns avoid the collision, the WTRU may select the pattern with smallest index number. The WTRU may indicate the selected ID to the network (e.g., via UCI, MAC-CE, RRC or LPP message). The WTRU may transmit SRS frequency hops according to the selected frequency hopping pattern. In some cases, if the WTRU is configured with periodic or semi-persistent SRS frequency hopping, the WTRU may retain the selected frequency hopping pattern. In some cases, if the WTRU cannot find any patterns that avoid the collision, the WTRU may transmit the scheduled uplink transmission instead of SRS frequency hops. In some cases, if the WTRU is not preconfigured with a list of SRS hopping patterns, the WTRU may determine to transmit the requested UL channel. In some cases, if the WTRU detects the collision later than the preconfigured time, the WTRU may transmit SRS frequency hops.

In some cases, the WTRU may be configured to cancel partial hops and partial transmissions. In some cases, if the WTRU receives an indication for scheduling uplink transmission (e.g., via DCI) earlier than the preconfigured time, and if there is a collision between uplink channel transmission and at least one of the hops in the SRS frequency hops, the WTRU may determine to cancel transmission of hops that collide with the uplink channel transmission. For example, in the example illustrated in FIG. 13, the WTRU may cancel a transmission of SRS hop #3 and transmit the scheduled PUCCH instead. The WTRU may determine a new transmission preparation time based on the scheduling indicator received from the network.

In some cases, the WTRU may be configured to postpone a transmission of SRS frequency hops. The WTRU may determine to prioritize uplink channel with a higher priority than SRS hops. If the WTRU is scheduled with resources, the WTRU may determine to transmit SRS hops in resources granted by the network (e.g., gNB).

In some cases, the WTRU may be configured with a window (e.g., the hop window illustrated in FIG. 2) during which the WTRU may transmit SRS hops. In some cases, the WTRU may determine to transmit canceled hop(s) or occasion(s) of SRS hops during the window. For example, the WTRU may transmit canceled SRSp hops or occasion(s) of hops (e.g., postpone transmission of SRS hops) for a preconfigured amount of duration (e.g., N slots). In some cases, the WTRU may determine to transmit the canceled SRS transmission if resources are available during the window. In some examples, the WTRU may determine the transmission time of a postponed SRSp hop or occasion of SRSp hops by repeating the pattern of SRSp transmissions in the time domain. For example, in case first and second SRSp hops would occur in symbol indices {0, 2, 4} and {1, 3, 5} of every slot respectively, and second SRSp hop transmission in symbol 3 would be cancelled, the WTRU may postpone transmission of the second SRSp hop in the next slot and in symbol index 1. The WTRU may determine to transmit hops in preconfigured indices of resources. For example, every 2^{nd} OFDM symbol, the WTRU may transmit the first hop on slot/symbol index 1, 3, and 5 and transmit the second hop on slot/symbol index 2, 4, and 6.

In some cases, the WTRU may be configured to transmit the required number of hop(s) or occasion(s) of hops. As such, if the WTRU determines to cancel transmission of SRS hop(s), the WTRU may retransmit a canceled SRS transmission until the requirement is satisfied. In some cases, the WTRU may attempt to retransmit the canceled SRS if the resources (e.g., granted by the network) are located within the preconfigured window. The WTRU may first be configured with a set of resources for the transmission of SRSp hops or occasion(s) of SRSp hops within a time window. The WTRU may transmit a SRSp hop or an occasion of SRSp hops in each resource if there is no collision with another transmission occurring on that resource and if the number of SRSp hops (or occasion(s) or SRSp hops) already transmitted over the window is lower than a target N of SRSp hops (or occasion(s) or SRSp hops). The target N may be signaled by higher layers.

In some cases, the WTRU may determine to postpone and/or reschedule SRS transmission using available resources due to a collision between SRS hop(s) and an uplink channel transmission, if a timeline requirement is met. In examples, a timeline requirement may include the WTRU receiving a request or determines to transmit an uplink channel (e.g., PUCCH, PUSCH) before (e.g., at least the preconfigured amount of time before) the first hop in the hopping pattern in the hopping occasion. In examples, a timeline requirement may include the WTRU receiving resources for retransmission and/or transmission of SRS hops along with the request to transmit the uplink channel from the network. In some cases, if the requirement is not met, the WTRU may determine to cancel retransmission of SRS hops that collided with the uplink channel.

In some cases, the WTRU may determine whether to postpone the canceled transmission based on the positioning method configured by the network. In examples, the WTRU may determine that the UL channel and at least one of the SRS hop transmissions collide. The request for UL channel transmission may be received at least M slots (e.g., transmission preparation time) before the transmission of the first SRS hop in the configured hopping pattern. In some cases (e.g., if the WTRU is configured with the UL-AoA positioning method) the WTRU may determine to transmit scheduled SRS hops in the next available resource. If there are not enough available resources for SRS transmission, the WTRU may determine to transmit SRS hops at the next occasion, such that there is no postponement. Available sources may be time and/or frequency resources that are configured and granted by the network for the WTRU to transmit SRS hops. In some cases, if the WTRU is configured with the RTT positioning method, the WTRU may determine to transmit scheduled SRS hops in the next available resource if the available resource is within a configured time limit (e.g., N slots) and/or time window. In some cases, if there are not enough available resources for SRS transmission, the WTRU may determine to transmit SRS hops at the next occasion, such that there is no postponement. In some cases, if the WTRU is configured with UL-RSTD, the WTRU may determine to transmit SRS hops at the next occasion, such that there is no postponement.

In some cases, the WTRU may be configured for adaptive measurement. In some cases, the WTRU may be configured to make measurements on received hops according to channel conditions. The WTRU may make measurements (e.g., RSTD, RSRP, AoA, AoD, etc.) using one or a combination of the received hops.

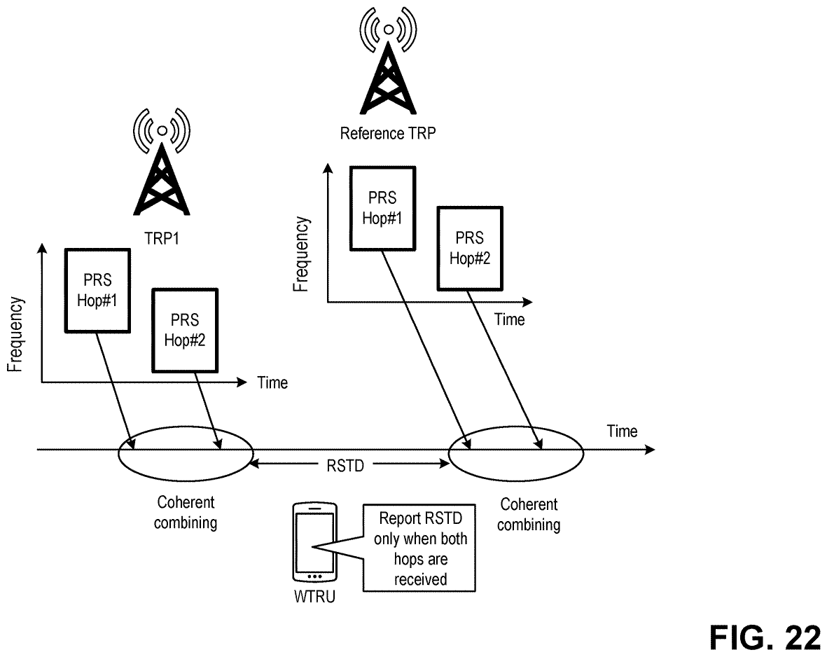

In some cases, the WTRU may be configured for adaptive measurement for frequency hopping (e.g., of RSTD). In some cases, the WTRU may determine to perform different types of measurements based on conditions (e.g., a channel condition, a LOS/NLOS condition, RSRP, etc.). Examples of types of RSTD measurements are illustrated in the figures. For example, FIG. 22 illustrates one RSTD measurement for an occasion of frequency hops. As illustrated in FIG. 22, the WTRU may receive PRS hops from a reference TRP and/or a target TRP (i.e., TRP1). The WTRU may receive one or more (e.g., all) hops (e.g., PRS hop #1 and PRS hop #2) in one occasion from both TRPs. For each occasion of hops received from reference and/or target TRP, the WTRU may perform measurements on the received time of arrival (ToA) if one or more (e.g., all) hops in the occasion are received. In some cases, the WTRU may measure the ToA when the second (e.g., the last) hop in the occasion is received. The WTRU may perform measurements on ToA for hops transmitted from the reference TRP and target TRP. The WTRU may compute RSTD by RSTD=ToA_reference−ToA_target. As such, the WTRU may determine ToA based on an accumulated PRS, thereby improving the quality of measurements.

An example of coherently combining, as illustrated in FIG. 22, may include averaging or correcting phase ambiguities among hops in the time domain, buffering the measurements, and performing FFT/DFT on the accumulated measurements, such that the measurements can be made in the frequency domain.

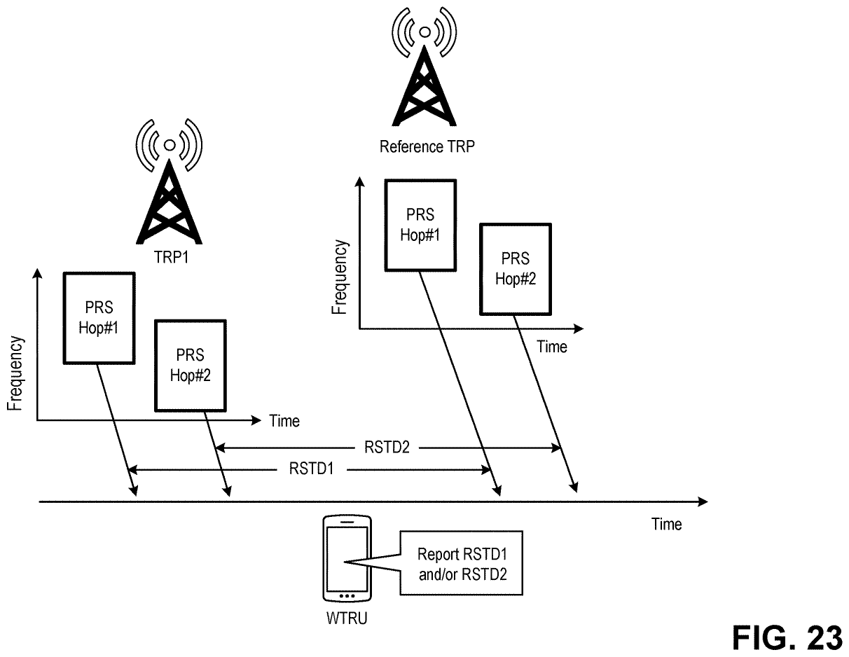

FIG. 23 illustrates an example of a per-hop pair RSTD measurement. As illustrated in FIG. 23, the WTRU may perform RSTD measurements per hop-pair. The hop-pair may be configured by the network. There may be two pairs of hops, in which the first pair is PRS hop #1 transmitted from the target TRP (TRP1) and the reference TRP. The second pair may be PRS hop #2 transmitted from the target TRP (TRP1) and the reference TRP. The WTRU may perform measurements on ToA for the PRS hop #1 from the reference TRP and target TRP. The WTRU may compute RSTD by RSTD=ToA_reference−ToA_target for PRS hop #1. The WTRU may perform measurements on ToA for the PRS hop #2 from the reference TRP and target TRP and computes RSTD by RSTD=ToA_reference−ToA_target for PRS hop #2.

In some cases, the WTRU may be configured to pair hops. the number of RSTD measurements may be equal to the number of hop-pairs. The WTRU may determine hop-pairing (and/or pairing of hops/pairs of hops) based on one or both of the following: the WTRU receiving pairings of hops from the network, and/or the WTRU determining pairing(s) of hops from frequency hopping patterns for PRSs (e.g., associated with reference TRPs and/or target TRPs). For example, if the number of hops for frequency hopping pattern configured for a reference TRP and a target TRP are the same, the WTRU may determine a one-to-one pairing. In such a case, the first pair may be PRS hop #1 transmitted from the target TRP (e.g., TRP1) and reference TRP. The second pair may be PRS hop #2 transmitted from the target TRP (e.g., TRP1) and reference TRP. In some cases, by measuring per pair of hops, the WTRU may determine ToA based on hop-pairing that makes measurements more robust against loss of PRS due to multipath channel or prioritization of transmission by the network.

In some cases, the WTRU may be configured with expected RSTD or an expected AoD. The WTRU may be configured with a parameter that assists the WTRU to measure RSTD or AoD for PRS. For example, the WTRU may be configured with an expected RSDT value such that once the WTRU measures the time of arrival for PRS from the reference TRP, the WTRU may expect when the PRS from the target TRP arrives. In some cases, the WTRU may be configured with an expected AoD per PRS resource such that the WTRU may have an approximate estimate AoD per PRS to improve its accuracy of detection of PRS. The WTRU may be configured with the expected RSTD and/or expected AoD per PRS hop pair. The WTRU may be configured with the expected RSTD per occasion or group of PRS hops.

In some cases, the WTRU may be configured with conditions to select the measurement method for the WTRU. The WTRU may determine to use one of the measurement methods discussed herein based on one or more of the following conditions. In examples, a condition may include WTRU being configured to use the measurement method. In examples, the WTRU may be configured to perform RSTD measurements per hop-pair. In examples, the condition may include cases in which the LOS indicator associated with the PRS transmitted from the reference and/or target TRP is less or equal to the preconfigured threshold. In such cases, the WTRU may determine to perform RSTD measurements per hop-pair. In examples, the condition may include cases in which the LOS indicator associated with the PRS transmitted from the reference TRP is above the preconfigured threshold. In such cases, the WTRU may determine to perform one RSTD measurement. In examples, the condition may include cases in which the RSRP of the PRS transmitted from reference and/or target TRP is less or equal to the preconfigured threshold. In such cases, the WTRU may determine to perform RSTD measurements per hop-pair. In examples, the condition may include cases in which the RSRP of the PRS transmitted from the reference TRP is above the preconfigured threshold. In such cases, the WTRU may determine to perform one RSTD measurement. In examples, the condition may include cases in which the WTRU detects more than one path for the PRS transmitted from the reference and/or target TRP. In such cases, the WTRU may determine to perform RSTD measurements per hop-pair. In examples, the condition may include cases in which the WTRU detects one path for PRS transmitted from a reference and/or target TRP. In such cases, the WTRU may determine to perform one RSTD measurement.

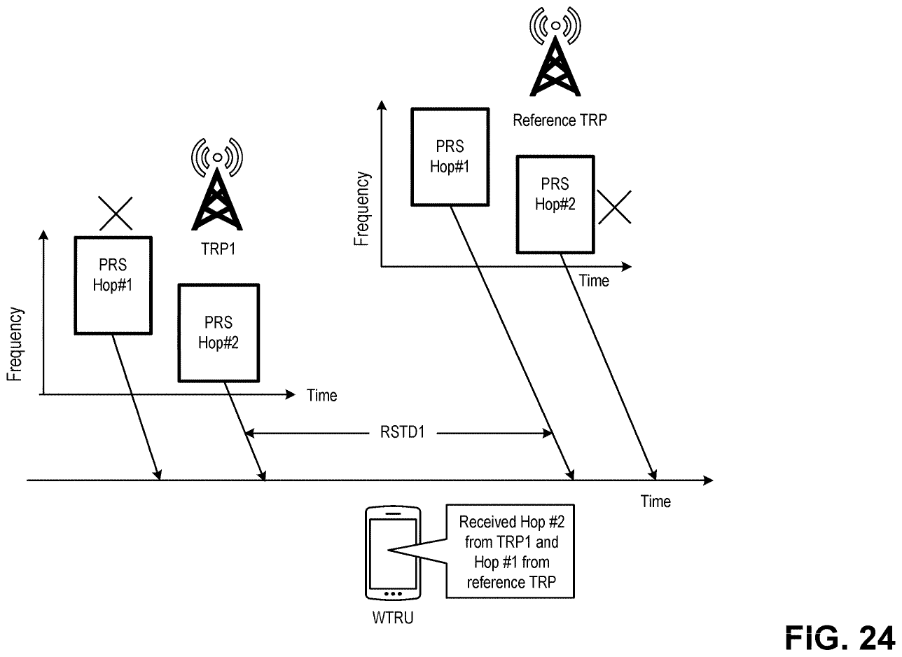

The WTRU may be configured to behave in a certain manner when a subset of PRS measurements from an occasion occurs. In some cases, the WTRU may determine to perform measurements (e.g., RSTD) on received hops where only a subset of hops from the occasion is received. FIG. 24 illustrates an example of a measurement on a partial occasion of hops. As illustrated in FIG. 24, the WTRU may receive hop #2 from TRP1 and hop #1 from the reference TRP. In some cases, one or more hops from TRP(s) may not be transmitted due to prioritization applied by the network. In some cases, the WTRU may determine to perform measurements on high priority downlink channels (e.g., PDCCH, PDSCH) if the priority level of the downlink channel is higher than PRS.

In some cases, if the WTRU performs measurements on a subset of hops from an occasion, the WTRU may determine to report measurements (e.g., RSTD) based on at least one of the following. The WTRU may report measurements for the cases in which RSTD is computed as ToA of the last hop measured and/or processed by the WTRU. In the example illustrated in FIG. 24, the WTRU may report RSTD computed based on ToA of PRS hop #2 from TRP1 (e.g., ToA_1) and ToA of PRS hop #1 from the reference TRP (e.g., ToA_r). For cases in which the WTRU reports RSTD to the network, the WTRU may report hop IDs (e.g., hop #1, hop #2) used to compute the RSTD (e.g., RSTD=ToA_r−ToA1). Hop #1 from TRP1 and/or hop #2 from the target TPR may not be processed by the WTRU due to lower priority of PRS compared to other downlink channels or measurement condition. For example, RSRP for the hops may be below the preconfigured threshold, in which the threshold is configured by the network.

In examples, the WTRU may report measurements for the cases in which the WTRU received and processed measurements from one or more (e.g., all) hops in an occasion from a TRP. The WTRU may derive ToA (e.g., ToA_c) based on one or more (e.g., all) hops in the occasion (e.g., via coherent combining). In some cases, if the WTRU received a subset of hops in the occasion, the WTRU may determine ToA, namely ToA_p, of the last hop measured and/or processed by the WTRU. In some cases, the WTRU computes RSTD based on the determined ToAs (e.g., RSTD=ToA_c−ToA_p).

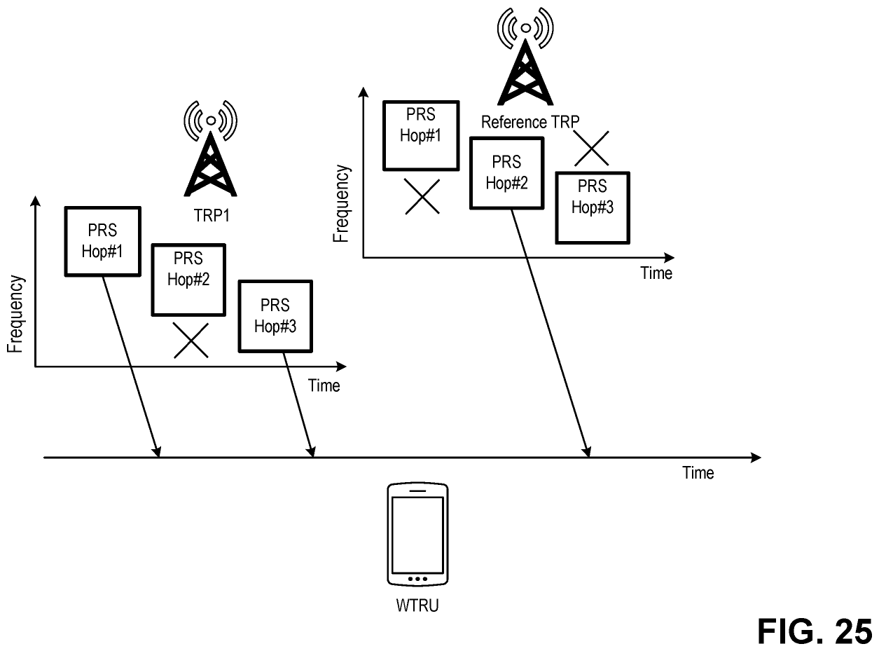

In examples, the WTRU may report measurements for the cases in which RSTD is computed based on partial measurements of hops. The WTRU may compute RSTD based on partial measurements of hops when the WTRU does not receive all hops in an occasion. In some occasions, the WTRU may perform measurements on one or more PRS hops in the occasion from the target/reference TRP(s). The WTRU may not receive and/or perform measurements on one or more hops from TRP(s). FIG. 25 illustrates an example of a measurement on a partial occasion of hops. As illustrated in FIG. 25, the WTRU may receive PRS hop #1 and #3 from TRP1 and PRS hop #2 from the reference TRP. The WTRU may determine to combine hops received from each TRP and determine to compute RSTD based on received hops (e.g., partial measurements). The WTRU may report the determined RSTD to the network. The WTRU may indicate one or more of the following to the network to indicate whether the WTRU received all hops or not. The WTRU may indicate via an indication flag (e.g., in which “1” indicates all hops are received and “0” indicates not all hops are received). The WTRU may indicate a fraction or percentage of hops received in an occasion (e.g., where “50” indicates 50% of hops in the occasion are received and “25” indicates 25% of hops in the occasion are received). The WTRU may indicate whether the WTRU received hops by providing indices of received PRS hop(s), whether the WTRU received one or more (e.g., all) hops (e.g., per occasion) or not, whether the WTRU is able to coherently combine the received hops (e.g., per occasion), quality indicator. A quality indicator may include fluctuations of RSTD and/or ToA per hop or occasion, expressed in time units (e.g., seconds, symbols, slots, etc.). In some cases, the WTRU may not incorporate any indication in the report (e.g., if not all hops in an occasion are transmitted by the network). For example, the WTRU may not incorporate any indication in the report, if not all hops in an occasion are transmitted by the network due to application of a muting as described herein.

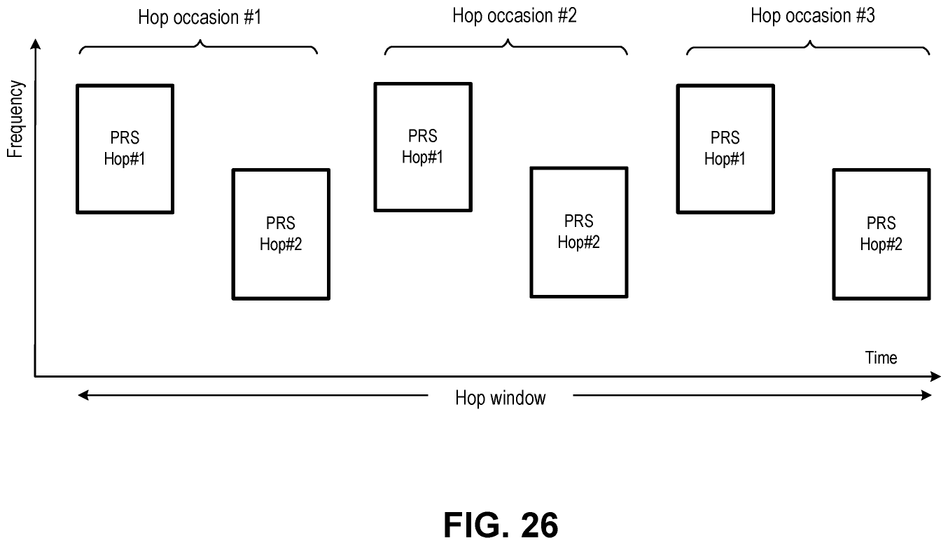

The WTRU may be configured for prioritization of PRS compared to DL channels. The WTRU may determine to prioritize PRS or DL channels (e.g., PDCCH, PDSCH) reception over DL channels or PRS, respectively. The WTRU may determine to prioritize PRS or DL channel reception over DL channel or PRS, respectively (e.g., based on the priority level configured for PRS and DL channels). The priority level may be configured by the network (e.g., gNB, LMF). In examples, the priority level may be indicated as “high”, “medium” or “low”, or numerically (e.g., 1 corresponds to high, 0.5 corresponds to medium, 0 corresponds to low). In some cases, the WTRU may determine to prioritize reception and processing of PRS or DL channels during a configured window. In examples, the configured window may be a PRS processing window, or hop window as illustrated in FIG. 26. FIG. 26 illustrates an example of a window (e.g., hop window or PRS processing window) configured to include occasion #1 to occasion #3 of DL frequency hops. In some cases, the WTRU may determine to measure downlink channels instead of PRS if one or more of the following conditions are satisfied.

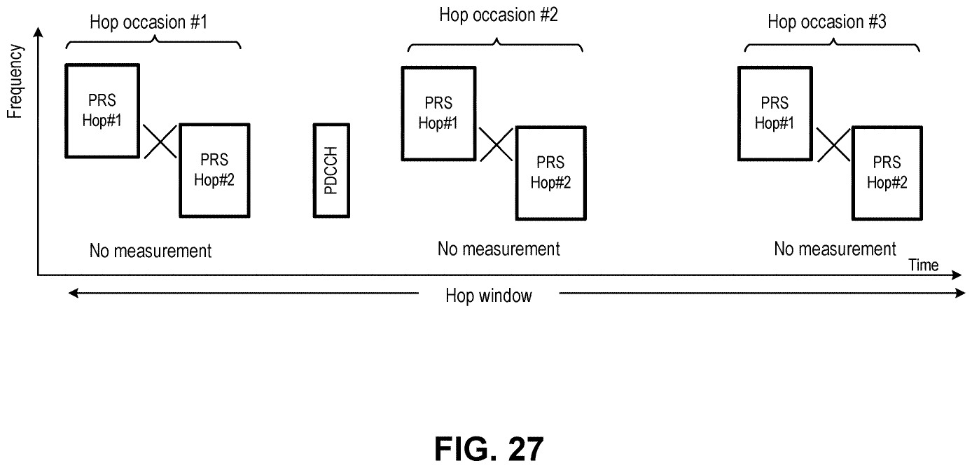

In examples, the WTRU may measure downlink channels instead of PRS for cases in which the WTRU is configured or determines (e.g., based on WTRU capability) to perform measurements on a PRS per window. In some cases, the WTRU may determine to measure downlink channel during the window, if a downlink channel(s) is received and/or scheduled during the window and priority level associated with the downlink channel is higher than that of PRS, even when the downlink channel does not collide with PRS during the window. FIG. 27 illustrates an example of a case in which a PDCCH with a higher priority level than PRS is received during a hop window in which the PDCCH does not collide with PRS during the window. As illustrated in FIG. 27, a WTRU may not perform measurements on one or more (e.g., all) hops in the same window as a PDCCH with a higher priority is scheduled within the window. If PDCCH is associated with a lower priority level than PRS and the PDCCH does not collide with PRS during the window, the WTRU may determine to perform a measurement on PRS and/or process measurements instead of processing PDCC. In examples, the WTRU may determine the priority level of PRS hops based on the priority level associated with the window or PRS hops.

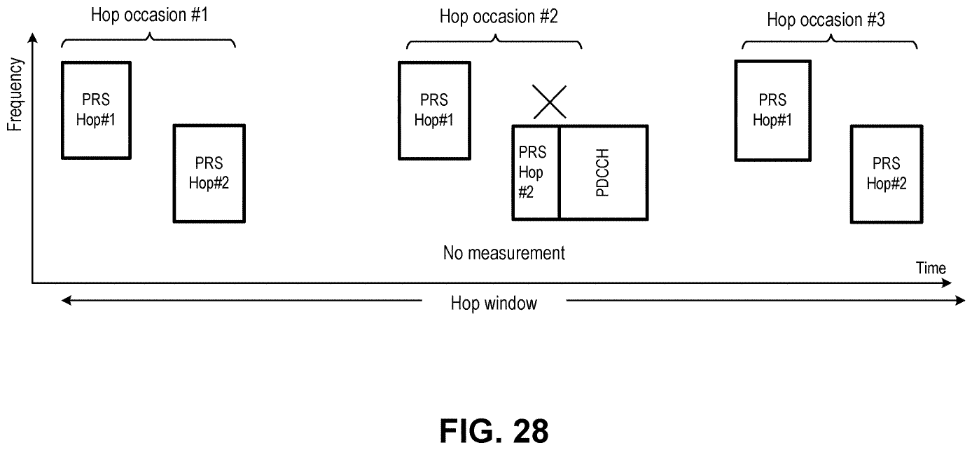

In examples, the WTRU may measure downlink channels instead of PRS, for cases in which the WTRU is configured and/or determines (e.g., based on WTRU capability) to perform measurements on PRS per hop(s). In some cases, the WTRU may determine to perform measurements on hops that do not collide with the higher priority downlink channel. As illustrated in FIG. 28, a PDCCH, with a higher priority than PRS, may collide with PRS hop #2 in hop occasion #2 in the window in which the WTRU does not perform measurement on the hop(s) that collide with higher priority downlink channels.

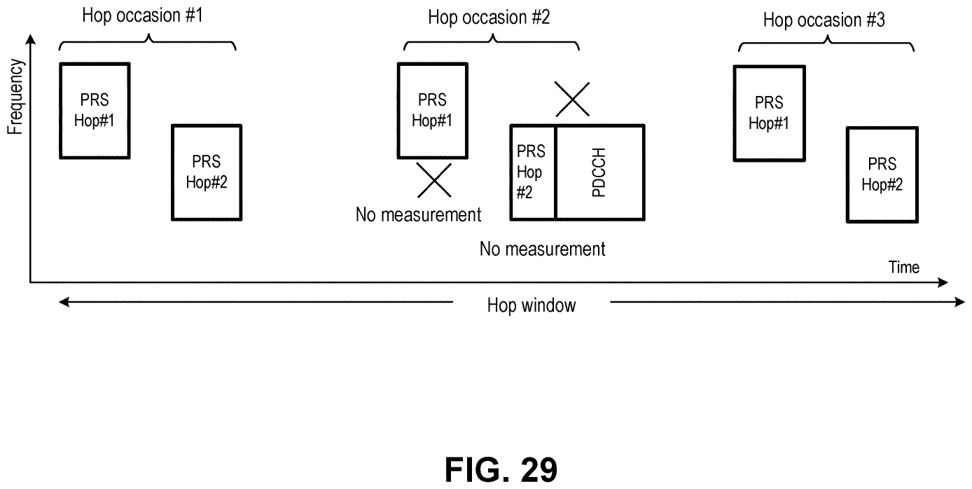

In examples, the WTRU may measure downlink channels instead of PRS for the cases in which the WTRU is configured or determines (e.g., based on WTRU capability) to perform measurements per a sub window or group of hops if a collision occurs between a downlink channel and PRS. The group or sub window may be based on a hop occasion, hops within an occasion, and/or a time window (e.g., configured with start/end time and duration). FIG. 29 illustrates an example of a prioritization between a downlink channel and PRS when the WTRU is expected to perform prioritization over an occasion. As illustrated in FIG. 29, the WTRU may determine prioritization within an occasion in the hop window. The WTRU may determine to process PDCCH processing over processing of measurements from PRS hop #1 and PRS hop #2 in hop occasion #2 (e.g., when the collision occurred within hop occasion #2 and where the PDCCH is associated with a higher priority compared to PRS).

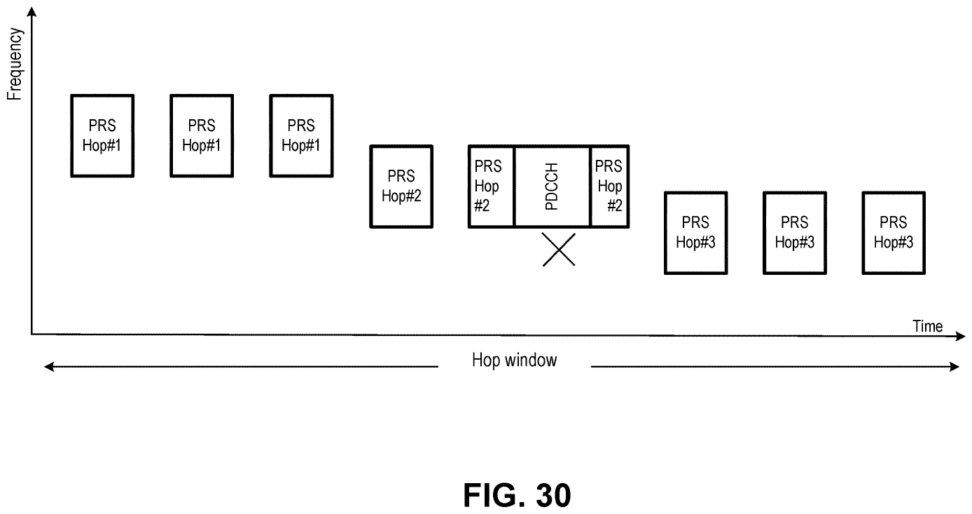

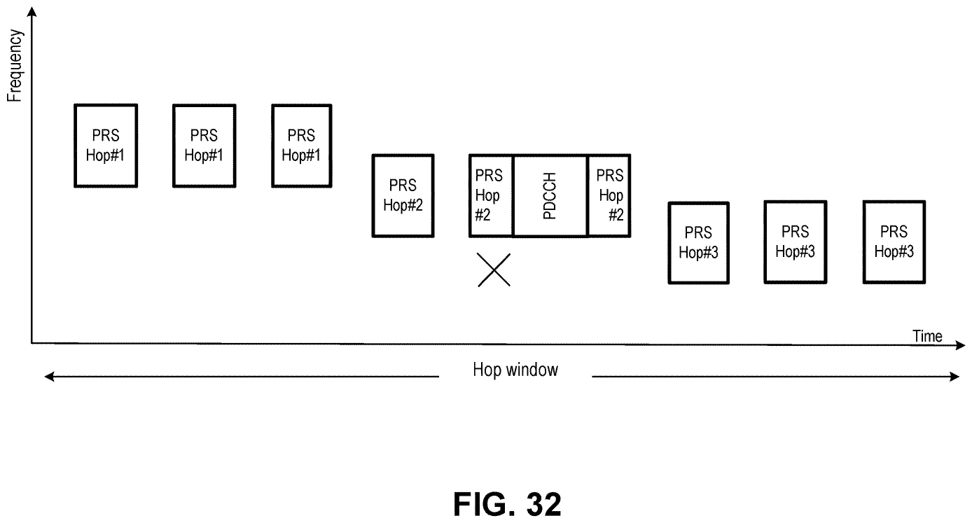

In some cases, the WTRU may be configured with collision behavior for repetition. FIG. 30 illustrates an example of collision behavior for repetition, in which the WTRU processes measurements for surviving hops. In some cases, the WTRU may be configured with repetitions of hops. As illustrated in FIG. 32, the scheduled downlink channel with a higher priority than PRS may collide with PRS hops. The WTRU may determine to process hops that do not collide with the downlink channel. As such, the WTRU may not process measurements corresponding to the 2^{nd} and 3^{rd} repetitions for PRS hop #2 since they collide with PDCCH.

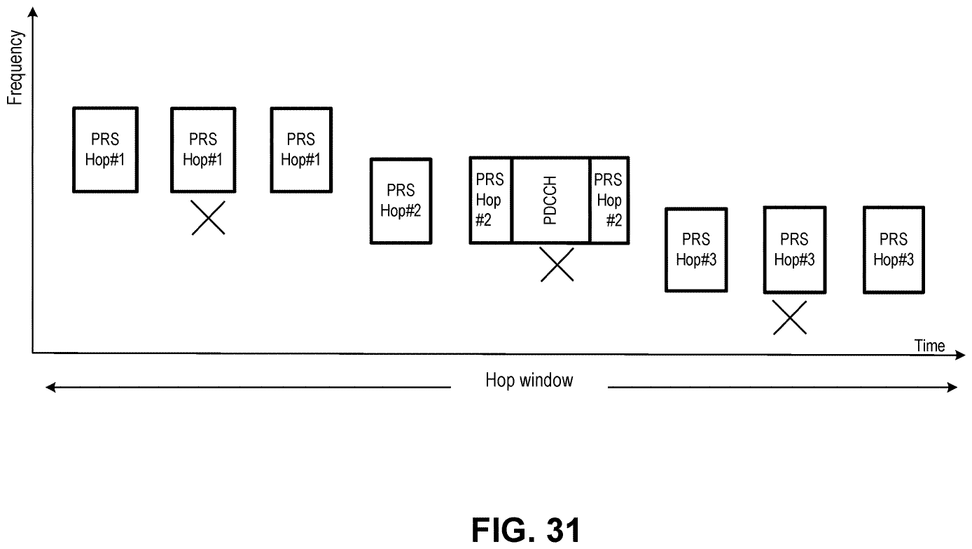

In some cases, the WTRU may determine to process a higher priority downlink channel, instead of PRS hops, during the PRS hop occasion. The WTRU may process the higher priority downlink channel (e.g., if the downlink channel is associated with higher priority than the PRS). FIG. 31 illustrates an example of collision behavior for repetition, in which the WTRU processes measurements for the downlink channel. As illustrated in FIG. 31, the downlink channel (e.g., PDCCH) may collide with the second and/or third repetition of PRS hop #2. In some cases, the WTRU may measure and/or process PDCCH during the occasion. In some cases, the WTRU may not measure and/or process measurements from the PRS hops in the occasion. The WTRU may or may not report the results to the network.

In some cases, the WTRU may determine to process a higher priority downlink channel, instead of repetitions of the collided PRS hop(s), during the PRS hop occasion. In some cases, the WTRU may process the higher priority downlink channel, if the downlink channel is associated with a higher priority than the PRS. FIG. 32 illustrates an example of collision behavior for repetition, in which the WTRU performs partial measurements on PRS hops. As illustrated in FIG. 32, the downlink channel (e.g., PDCCH) may collide with the second and/or third repetition of PRS hop #2. The WTRU may measure and/or process PDCCH. In some cases, the WTRU may not measure and/or process measurements from the repetitions of PRS hop index that collide with the downlink channel (e.g., hop #2 in this example).

In some cases, the WTRU may be configured for adaptive measurement for DL-TDOA. The WTRU may receive, from the network (e.g., via LMF, gNB, or the like), PRS configurations (e.g., reference and/or target TRP ID, PRS resource ID), configurations for PRS hopping pattern (e.g., number of hops in an occasion of hops, duration of each hop, PRS hopping pattern for reference and target TRP ID) and one or more of the following. The WTRU may receive PRS configurations and configurations for PRS hopping patterns, in which a hopping pattern includes a set of two or more hops per hopping occasion and a hopping occasion corresponds to a time unit (e.g., symbol or slot) or time span of multiple time units. In examples, the WTRU may receive PRS configurations and/or configurations for PRS hopping patterns, in which a hopping pattern includes two or more hops, in which each hop is associated with ID (e.g., index). In examples, the WTRU may receive PRS configurations and configurations for PRS hopping patterns, in which a first hop in a hopping occasion corresponds to a first set of frequency resources and a second hop in a hopping occasion corresponds to a second set of frequency resources that overlaps or does not overlap with the first set of frequency resources. In some cases, the second set of frequency resources may not be the same as the first set of frequency resources. In examples, the WTRU may receive PRS configurations and configurations for PRS hopping pattern, in which both target and reference TRP transmits PRS according to the same frequency hopping pattern.

In some cases, the WTRU is configured to perform DL-TDOA. The WTRU may receive, from the network, one or more configurations corresponding to pairing of hops. A pair of hops may include a hop index for PRS transmitted from the reference TRP and target TRPs. Each hop pair may be associated with a pair index. For example, if a hopping pattern of PRS transmitted from a target and reference TRP includes two hops (e.g., hop #1 and hop #2), two pairs of hops may be one pair including hop #1 from reference TRP and hop #1 from target TRP, and another pair including hop #2 from reference TRP and hop #2 from target TRP.

In some cases, the WTRU may receive an LOS indicator associated with the PRS transmitted from the reference TRP from the network. If the LOS indicator is greater than or equal to the threshold and the WTRU receives one or more (e.g., all) hops in the occasion, the WTRU may perform one RSTD measurement for the one or more (e.g., all) hops in the occasion. If the LOS indicator is below the threshold and the WTRU receives both hops in a pair of hops, the WTRU may measure RSTD per received paired hop, in which an RSTD measurement is associated with the pair index. In some cases, the WTRU may report the RSTD(s) to the network. In examples, the RSTD(s) may be based on one or more (e.g., all) hops or RSTD per paired hops.

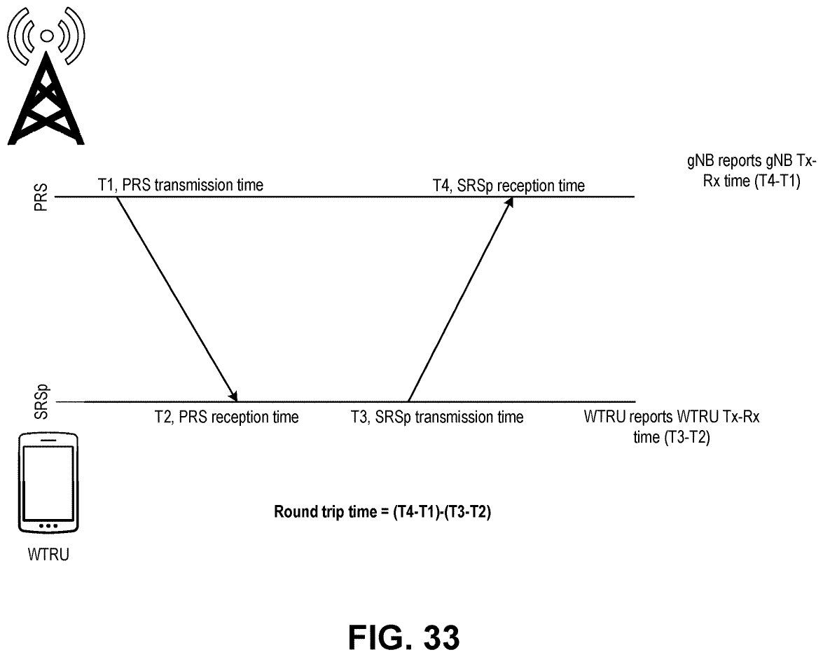

In some cases, the WTRU may be configured for adaptive measurement for frequency hopping (e.g., RTT). The WTRU may report a difference in time of arrival of PRS and SRSp (or SRS) transmission time to the network, such that the network can compute a round trip time. FIG. 33 illustrates an example computation of a round trip time. As illustrated in FIG. 33, the WTRU may compute a difference between the time of arrival of PRS (e.g., T2 in FIG. 33) and the transmission time of the configured SRSp (e.g., T3 in FIG. 33) to the network. The difference between ToA and time of transmission may be referred to as “WTRU Tx-Rx time difference” herein.

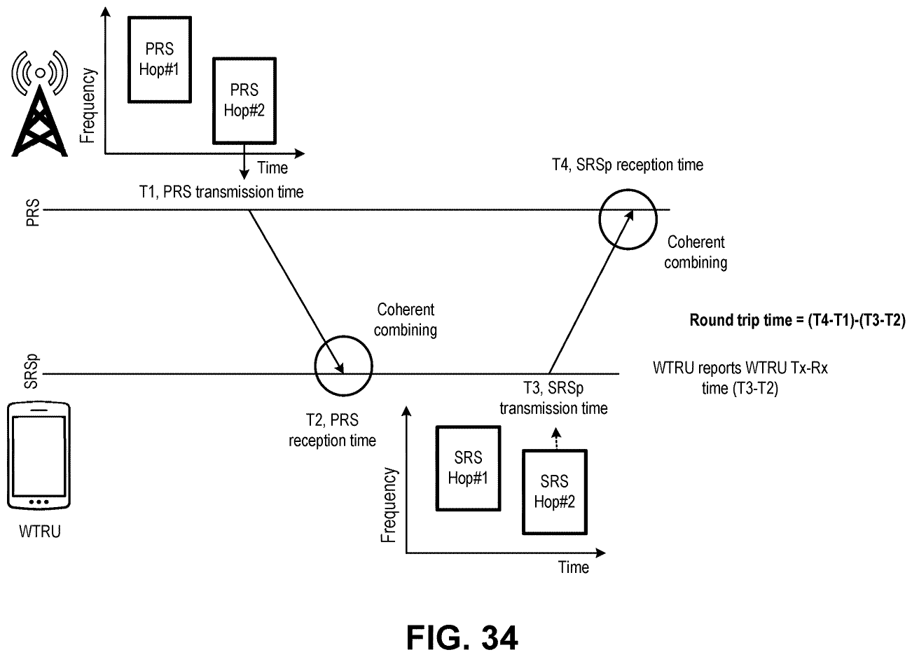

In some cases, the WTRU may be configured to determine Rx-Tx time as coherently combined measurements. FIG. 34 illustrates an example showing how coherent combining may be used in conjunction with calculations related to Rx-Tx time (e.g., in a computation similar to the one shown in FIG. 33). For example, the WTRU may determine the arrival time of PRS based on the time of arrival of the last PRS hop, PRS Hop #2 in FIG. 34. The WTRU may determine the time of departure of SRSp based on the time of departure of the last SRSp hop, SRS Hop #2 in FIG. 34. The WTRU may determine that both PRS hopping patterns and SRS hopping patterns are configured. The WTRU may receive hopping patterns from the network. The WTRU may receive PRS hopping patterns from the LMF (e.g., via LPP message). The WTRU may receive SRS hopping patterns from the gNB (e.g., via RRC).

In some cases, the WTRU may determine to combine received PRS hops. The WTRU may determine a time of arrival for the hops. The WTRU may receive an indication from the network to coherently combine the measurements. In some cases, the WTRU may determine the time of arrival for hops based on one or both of the following: the average time of arrival, and/or the earliest or latest time of arrival of a group of hops. An example of the average time of arrival may be T1 and T2 as times of arrival for PRS hop #1 and #2, respectively, and a time of arrival for coherently combined hops is (T1+T2)/2. An example of the earliest or latest time of arrival of a group of hops may be T1, T2, T3 as times of arrival for PRS hop #1, #2 and #3, respectively, and T1<T2<T3 are ordered in terms of time of arrival. The earliest time of arrival is T1, and the latest time of arrival is T3 for the group including PRS hop #1, #2 and #3.

In some cases, the WTRU may determine a transmission time for SRS hops based on one or both of the average time of transmission, and/or the time of transmission of a group of hops (e.g., the earliest or latest time of transmission). The average time of transmission may be, for example, T1 and T2 as times of transmission for SRS hop #1 and #2, respectively, and a time of arrival for coherently combined hops is (T1+T2)/2. The earliest or latest time of transmission of a group of hops may be T1, T2, T3 as times of transmission for SRS hop #1, #2 and #3, respectively, and T1<T2<T3 are ordered in terms of time of transmission. The earliest time of arrival is T1, and the latest time of transmission is T3 for the group including SRS hop #1, #2 and #3.

In some cases, the WTRU may determine to report measurements (e.g., WTRU Rx-Tx time) if the WTRU received one or more (e.g., all) PRS hops in one occasion. The WTRU may transmit one or more (e.g., all) SRS hops in one occasion associated with the measurement.

In some cases, if the WTRU is configured with a normal PRS or a normal SRS transmission, the WTRU may determine a time of arrival of PRS or a transmission time of SRS. The WTRU may determine the time of arrival of PRS, or the transmission time of SRS based on the reception or transmission of the configured PRS or SRS. A normal PRS may be, for example, a PRS transmission that does not require hops. A normal SRS transmission may be, for example, an SRS transmission that does not require hops. A transmission time of SRS may be, for example, a time of departure denoted as ToD.

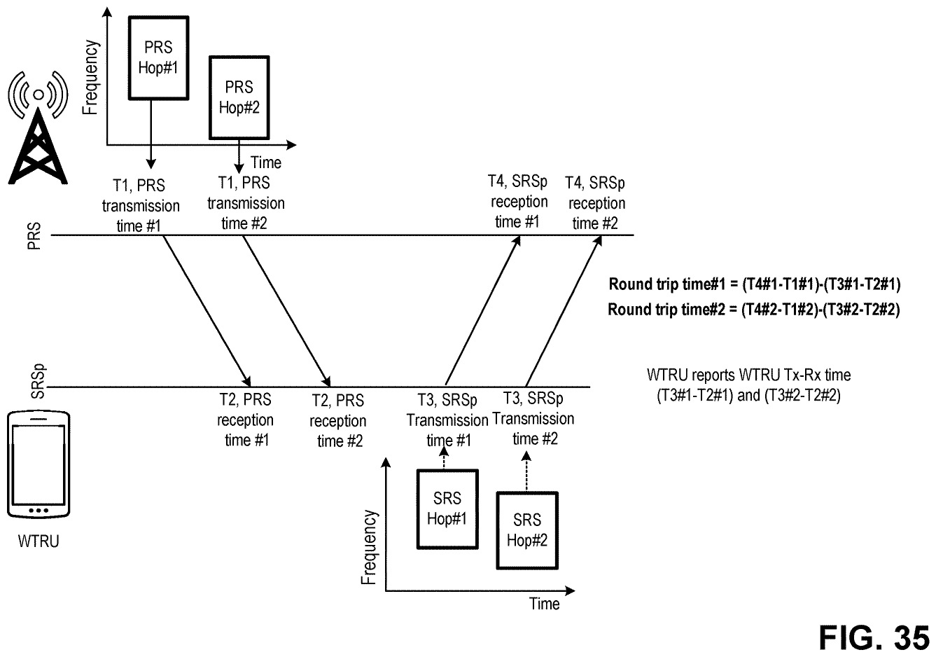

In some cases, the WTRU may be configured to determine Rx-Tx time as partially combined measurements. The WTRU may determine a WTRU Tx-Rx time based on a pair of PRS and SRS resource. The WTRU may receive configurations for the pair of PRS and SRS resources from the network. FIG. 35 illustrates an example of pairwise determination of WTRU Rx-Tx time. FIG. 35 illustrates two pairs: PRS hop #1 and SRS hop #1, and PRS hop #2 and SRS hop #2. The WTRU may report respective WTRU Tx-Rx time based on configured pairs. For example, the WTRU may report two WTRU Tx-Rx time measurements (e.g., one for each pair). For instance, the WTRU reports a WTRU Tx-Rx time measurement for the pair PRS hop #1 and SRS hop #1, indicated as T3 #1-T2 #1 in FIG. 35, and the WTRU reports another WTRU Tx-Rx time measurement for the pair PRS hop #2 and SRS hop #2 indicated as T3 #2-T2 #2 in FIG. 35. In some cases, by reporting the measurements pairwise, the RTT time computation at the network may be more robust (e.g., in case the WTRU cannot perform at least one of the PRS measurements such as the ToA of PRS, or the WTRU determines to cancel at least one of the SRS transmissions).

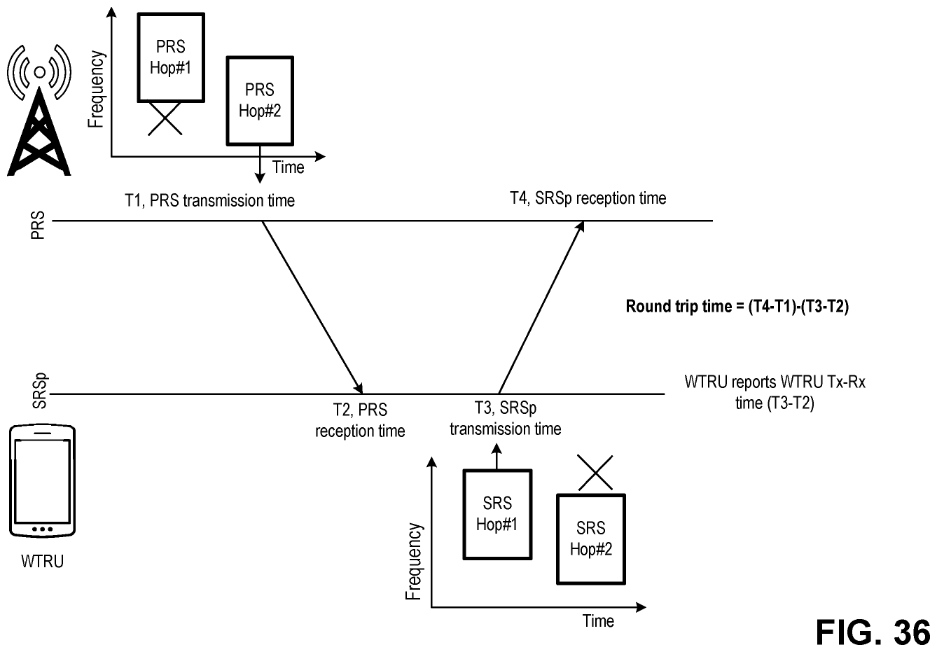

In some cases, the WTRU may determine a WTRU Rx-Tx time based on received PRS hop(s) or transmitted SRS hop(s). FIG. 36 illustrates an example of a determination of WTRU Rx-Tx time based on partial measurements. As illustrated in FIG. 36, the WTRU may not receive PRS hop #1 from the network and may not transmit SRS hop #2. In some cases, the WTRU may determine a WTRU Rx-Tx time based on at least one or combination of the following rules. In examples, the WTRU may determine ToA for PRS hop(s) based on the average of ToA for the received PRS hop(s). In examples, the WTRU may determine ToA for PRS hop(s) based on the earliest and/or latest ToA for the received PRS hop(s). In some cases, the WTRU may determine time of departure (ToD) or a transmission time for SRS hop(s) based on the average of ToD for the transmitted SRS hop(s). In some cases, the WTRU may determine ToD or a transmission time for SRS hop(s) based on the earliest and/or latest ToD for the transmitted SRS hop(s).

In some cases, the WTRU may determine a WTRU Tx-Rx time, which is computed as ToD-ToA, based on the determined ToA and ToD. The WTRU may receive an indication from the network to derive the measurements (e.g., for WTRU Rx-Tx time) based on the preconfigured rule(s) described herein.

In some cases, the WTRU may be configured to determine partial and/or coherent combining of measurements. The WTRU may determine to coherently combine PRS measurements (e.g., ToA) or derive ToA based on received PRS hops based on the conditions described herein (e.g., channel conditions as described herein). The WTRU may determine to coherently combine SRS measurements (e.g., ToD) or derive ToD from transmitted SRS hops based on one or more of the following. For example, the WTRU may coherently combine ToDs for SRS hops if one or more (e.g., all) SRS hops in an occasion are transmitted. In examples, the WTRU may derive ToD if one or more SRS hops in an occasion are not transmitted.

In some cases, the WTRU may include an indication in the measurement report that a WTRU Rx-Tx time is derived based on coherently combined measurements. In some cases, the WTRU may include one or more of the following indications in the report: both ToA and ToD are derived coherently; only ToA is derived coherently; only ToD is derived coherently; or neither ToA nor ToD is derived coherently.

In some cases, the WTRU may be configured to determine a hopping pattern for RTT based on the common hopping configuration. The WTRU may determine a hopping pattern for PRS and/or SRS hopping based on the common configured pattern. The common configured pattern may be applicable to PRS hopping pattern, Rx hopping pattern, and/or SRS hopping pattern. In some cases, the WTRU may apply the common pattern to at least one or a combination of the following: a PRS hopping pattern, a Rx hopping pattern, and/or an SRS hopping pattern. By using the common frequency hopping pattern, overhead for signaling to the WTRU may be reduced.

In some cases, based on a condition, the WTRU may apply the configured pattern for performing measurements on PRS hops and/or transmission of SRS hops. In some cases, the WTRU may use the common configuration based on one or more of the following. The WTRU may be indicated to use the common configuration for Rx hopping, PRS hopping and/or SRS hopping. In examples, the WTRU is configured to perform RTT positioning, however, the WTRU may not be configured with Rx hopping, PRS hopping and/or SRS hopping.

In some cases, the WTRU may receive an indication from the network (e.g., LMF, gNB) to use a common frequency hopping pattern for performing measurements on PRS hops and/or transmission of SRS hops. The common frequency hopping pattern may be expressed in terms of a limited number of hopping parameters. For example, the WTRU may receive the common frequency patterns with parameters including but not limited to, a number of hops, hop gap, BW overlap, and/or hopping bandwidth. The WTRU may determine the starting and/or end frequency based on DL or UL transmission configuration (e.g., center frequency, starting frequency of the hops, frequency hopping bandwidth). The WTRU may determine a hop gap and/or a BW overlap based on DL or UL transmission configuration.

In some cases, the WTRU may be configured to mute hops by the network. The WTRU may be configured with a muting pattern for PRS hopping. In general, muting may be used by the network to suppress interference of PRS. In some cases, the WTRU may be configured with a muting pattern that mutes one or more than one occasions of PRS hopping patterns.

In some examples, (e.g., as illustrated in FIG. 7A) if the WTRU is configured with repetitions of a PRS hopping pattern, the WTRU may receive a muting pattern [1 0 1] that indicates to the WTRU that hop occasion #2 is not transmitted by the network. As such, the WTRU may receive hop occasion #1, #3, #4, #6, etc.

In examples, the WTRU may receive a muting pattern that mutes a subset of hops in an occasion. For example, (e.g., as illustrated in FIG. 7B) if the WTRU is configured repetitions of hops in a pattern, the WTRU may receive a muting pattern [1 1 0] in which the WTRU is expected to receive a first and second repetition for each hop. For example, as illustrated in FIG. 7B, the WTRU receives the first and second repetition of hop #1, #2, and #3, etc.

In examples, if the WTRU is configured with repetitions of a PRS hopping pattern as illustrated in FIG. 7A, the WTRU may receive a muting pattern that is applicable to hops in each occasion [1 0 1]. For instance, the WTRU may receive PRS hop #1 and hop #3 in each occasion.

In some cases, the WTRU may receive an indication (e.g., via LPP, RRC, MAC-CE or DCI) from the network of the unit applicable to the muting pattern. In examples, the unit may be a hop in one or more occasions. The WTRU may receive both indications. In such cases, the WTRU may combine the muting patterns (e.g., via logical AND operation) and determine which hop that the WTRU can receive. For example, as illustrated in FIG. 7A, if the WTRU receives, from the network, muting patterns [1 0 1] and [1 1 0] which are applicable to an occasion and hops in each occasion, respectively, the WTRU may determine to receive the following hops: hop #1 and hop #2 in hop occasion #1, hop #1 and hop #1 and hop #2 in hop occasion #3, hop #1 and hop #2 in hop occasion #4, hop #1 and hop #1 and hop #2 in hop occasion #6, etc.

For cases in which the WTRU receives partial hops (e.g., not all hops in an occasion are transmitted), the WTRU may perform measurements on received hops and report measurements as described herein.

In some cases, the WTRU may determine muting patterns are applied based on a configured positioning method. For example, the WTRU may determine that the configured muting pattern is applied if an angle-based positioning method (e.g., DL-AoD) is configured by the network. In examples, the WTRU may determine that the configured muting pattern is not applied if a timing-based positioning method (e.g., DL-TDOA) is configured by the network.

In some cases, the WTRU may be configured for adaptive measurements for frequency hopping (e.g., AoD, AoA). In some cases, the WTRU may perform measurements (e.g., RSRP) on PRS based on received hops. As illustrated in FIG. 25, based on received PRS hops from TRP1, the WTRU may perform RSRP measurements based on one or a combination of the following behaviors. The WTRU may perform RSRP measurement per PRS hop. The WTRU may report RSRP per hop to the network, associating RSRP measurement to the corresponding hop index. The WTRU may combine the RSRP measurements (e.g., an average of the RSRP measurements, maximum and/or minimum RSRP measurements). The WTRU may report the combined RSRP measurement to the network. In some cases, the WTRU may report indices of received PRS hops. In examples, the WTRU may include a quality indicator for each measurement. The quality indicator may include one or more of levels of qualities, fluctuations of measurements (e.g., +/−0.01 dB), standard deviation, and/or variance of the measurement. The WTRU may include the indicator for a combined RSRP measurement or individual RSRP measurement per hop. In examples, the WTRU may include an indicator of whether all hops in an occasion(s)/pattern(s) are received in the measurement report. In examples, the indicator value of 1 may indicate that all hops in the occasion(s)/pattern(s) are received by the WTRU, while an indicator value of 0 may indicate that not all hops are received by the WTRU. In examples, the WTRU may indicate the percentage or proportion of hops received in the measurement report. For example, the WTRU may indicate that 50% of hops in the occasion are received.

In some cases, the WTRU may be configured for Rx hopping. The WTRU may be configured for adaptive measurement for Rx hopping via RSRP. The WTRU may be configured for adaptive measurements, such as one measurement per hop.

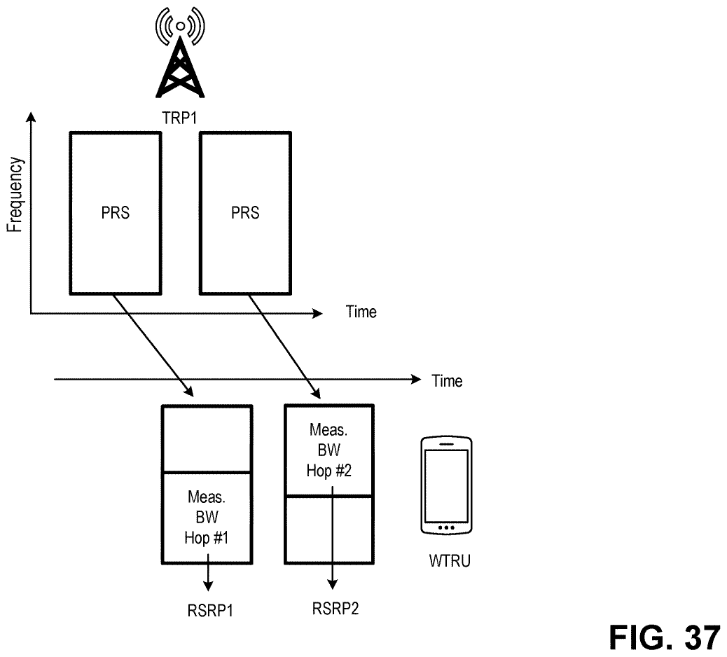

In some cases, the WTRU may be configured with an Rx hopping pattern. The WTRU may determine to make RSRP measurements per hop (e.g., as illustrated in FIG. 37). In examples, the WTRU may be configured to receive two occasions of PRS. The WTRU may be configured to perform measurements based on an Rx hopping pattern. The WTRU may perform RSRP measurements for hop #1 and hop #2, separately. The WTRU may report to the network two RSRP measurements, in which each measurement corresponds to each hop. In some cases, the WTRU may perform separate RSRP measurements per hop based on at least one or more of the following. The WTRU may perform separate RSRP measurements for the cases in which the WTRU receives an indication from the network to make separate measurement (e.g., RSRP, RSTD, ToA, AoA, AoD) per hop. The WTRU may perform separate RSRP measurements for the cases in which the LOS indicator associated with the PRS is below or above a preconfigured threshold, such that the LOS indicator may be determined by the WTRU or received from the network. The WTRU may perform separate RSRP measurements for the cases in which an RSRP associated with the PRS is below or above a preconfigured threshold, such that the RSRP measurement may be the minimum, maximum, or average RSRP measured across hops in the occasion. In examples, the WTRU may perform separate RSRP measurements for the cases in which the WTRU measures one or more paths based on the measurements obtained from PRS. In examples, the WTRU may perform separate RSRP measurements for the cases in which quality of measurements (e.g., RSRP) is below or above the threshold, such that a RSRP measurement may be the minimum, maximum, or average RSRP measured across hops in the occasion. In examples, the WTRU may perform separate RSRP measurements for the cases in which a quality of the LOS indicator determined by the WTRU or NW is below or above the threshold.

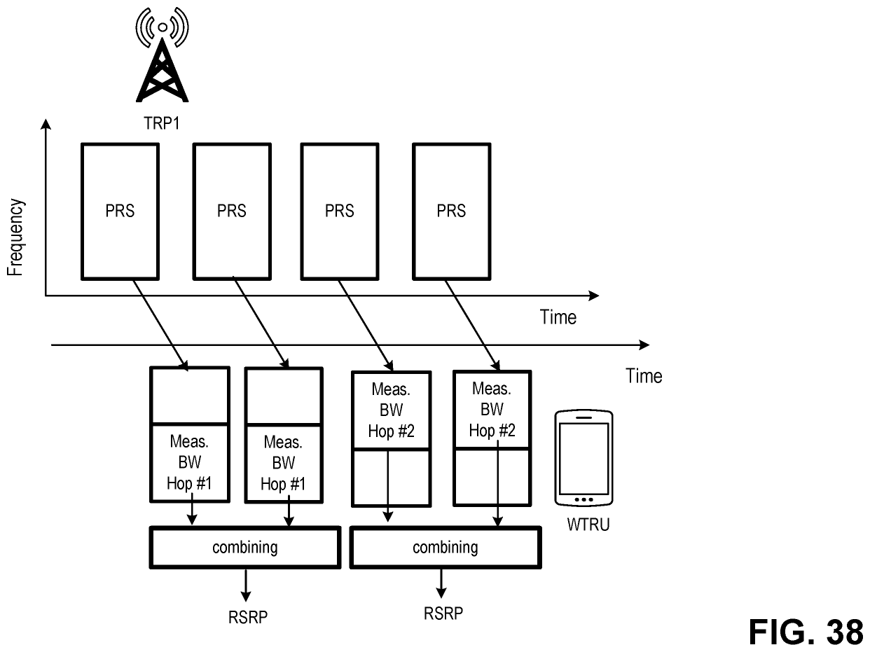

In some cases, the WTRU may be configured for an Rx hopping pattern based on a repetition factor. If the measurement hop repetition is configured, the WTRU may perform one measurement for all repetitions or per repetition. As illustrated in FIG. 38, the WTRU may be configured with two hops and two measurements per hop. The WTRU may determine to perform measurements and/or combine (e.g., via averaging or determining a maximum or minimum) measurements made over the two or more repeated Rx hops.

In some cases, the WTRU may send an indication to the network (e.g., via a measurement report) to indicate to the network that the measurement is the result of the combination. The combination result may be determined by averaging or determining a maximum or minimum of the measurements made based on a Rx hopping pattern.

In some cases, the WTRU may receive configurations for repetition factor(s) for PRS. In the example shown in FIG. 38, the repetition factor for PRS is four. The repetition factor may be configured for the normal PRS. For example, the repetition factor may be configured for one or more of PRS for legacy WTRUs, PRS with bandwidth configured for normal WTRUs, and/or PRS without hops.

The WTRU may be configured to perform measurements on the normal PRS based on a Rx hopping pattern based on the WTRU capability. For example, the WTRU may have a reduced capability. The WTRU may determine the Rx hopping pattern based on the default configuration or preset configuration (e.g., hard coded in the WTRU specifications). In some cases, the WTRU may be configured with the default configuration. In some cases, with respect to a preset configuration, there may be an implicit understanding between the network and WTRU about an Rx hopping pattern that the WTRU follows to perform measurements. In some cases, the WTRU may determine the default Rx hopping pattern based on a message from the network. In examples, the message may be an RRC, LPP, SIB, MAC-CE, or DCI message, or any other type of message.

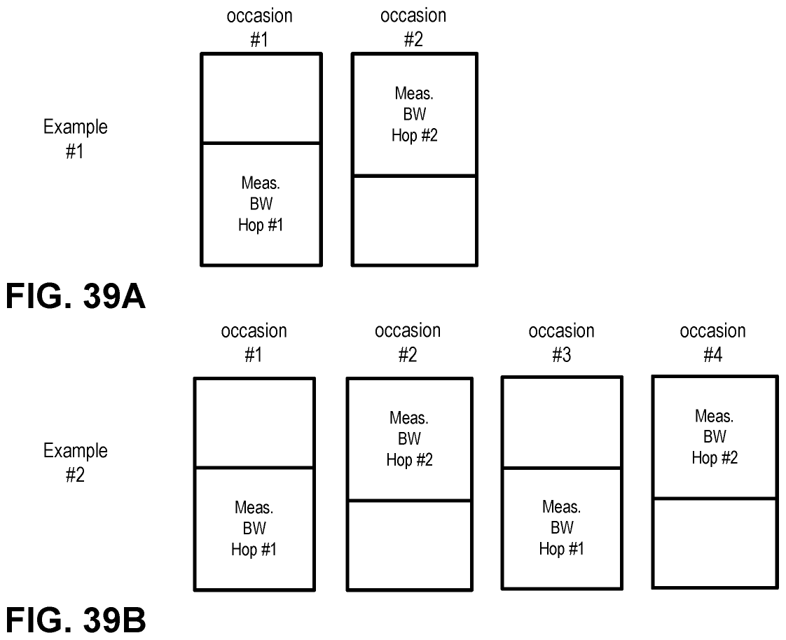

In some cases, the WTRU may determine the default, preset, and/or configured Rx hopping pattern based on the repetition factor. For example, as illustrated in FIG. 39A, the WTRU may use an Rx hopping pattern for the repetition factor of two. In examples, as illustrated in FIG. 39B, if the WTRU is configured with a repetition factor of four, the WTRU may determine to repeat the Rx hopping factor used for the repetition factor of two.

In some cases, the WTRU may be preconfigured with a mapping table that maps the repetition factor to an Rx hopping pattern. Based on the configured repetition factor, the WTRU may perform measurements on PRS based on the Rx hopping pattern associated with the Rx hopping pattern.

In some cases, the WTRU may be preconfigured with a mapping table that maps the bandwidth of PRS to an Rx hopping pattern. For example, the WTRU may be configured with the bandwidth for PRS. The WTRU may determine an Rx hopping pattern associated with the bandwidth.

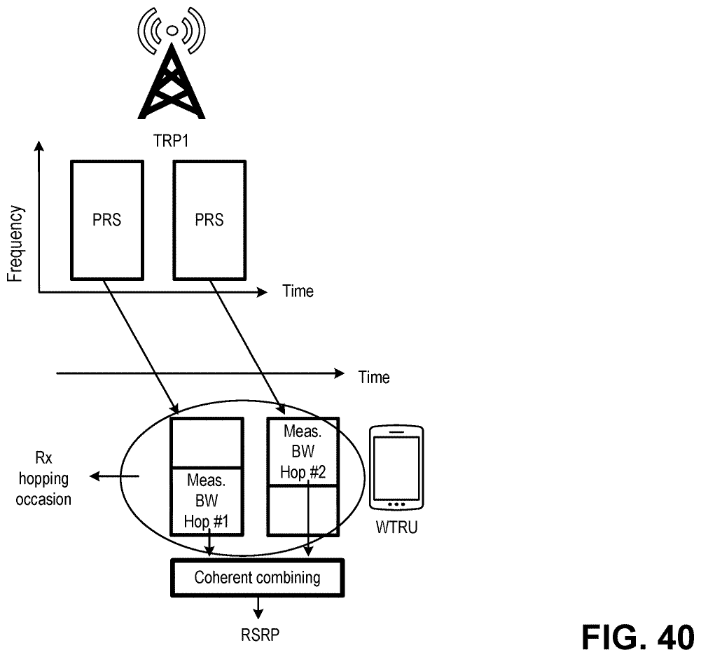

In some cases, the WTRU may be configured for adaptive measurements, such as one measurement per occasion. In some cases, the WTRU may make one measurement per occasion. For example, as illustrated in FIG. 40, the WTRU may perform two RSRP measurements, one RSRP measurement per hop, and combine the measurements to make one RSRP measurement per Rx hop occasion. In examples, combining measurements may include averaging and/or removing any phase ambiguities among hops. The WTRU may report the combined measurement to the network. In some cases, the WTRU may perform one measurement per Rx frequency hop occasion based on at least one or more of the following. The WTRU may receive an indication from the network to make one measurement (e.g., RSRP, RSTD, ToA, AoA, AoD) per occasion. The WTRU may perform the measurement for the cases in which the LOS indicator associated with the PRS is below or above a preconfigured threshold. The LOS indicator may be determined by the WTRU or received from the network. In examples, the WTRU may perform the measurement for the cases in which the RSRP associated with the PRS is below or above a preconfigured threshold. In examples, the RSRP measurement may be the minimum, maximum, or average RSRP measured across hops in the occasion. In examples, the WTRU may perform the measurement for the cases in which the WTRU measures one path based on the measurements obtained from PRS. In examples, the WTRU may perform the measurement for the cases in which a quality of measurements (e.g., RSRP) is below or above the threshold, such that a RSRP measurement may be the minimum, maximum, or average RSRP measured across hops in the occasion. In examples, the WTRU may perform the measurement for the cases in which a quality of the LOS indicator determined by the WTRU or NW is below or above the threshold.

In some cases, the WTRU may be configured to select a Rx hopping pattern. An Rx hopping pattern, or WTRU measurement behavior, may be determined by the network or the WTRU. In some cases, the network may be configured with the Rx hopping pattern based on channel characteristics, such as time selective frequency selectivity, etc. In some cases, the WTRU may determine the Rx hopping pattern based on, RF tuning time and channel characteristics.

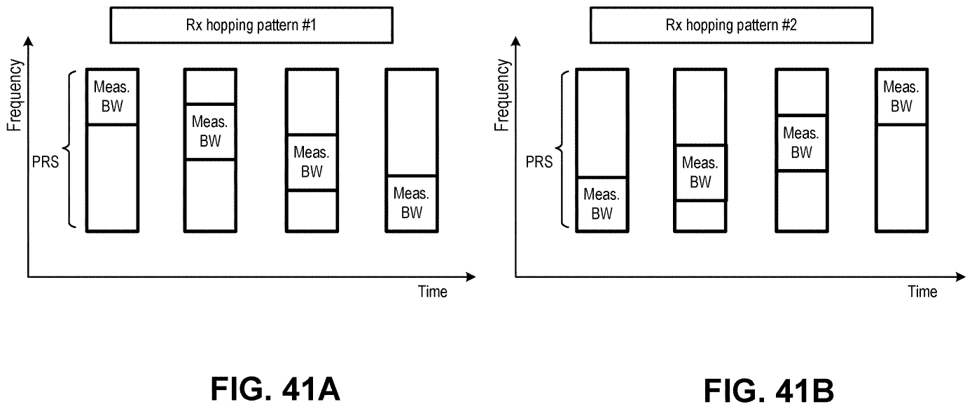

In some cases, the WTRU may receive a list of Rx hopping patterns from the network. FIG. 41A and FIG. 41B illustrate different Rx frequency hopping patterns. Each hopping pattern may be associated with a different ID number.

In some cases, the WTRU may receive an indication from the network (e.g., via DCI, MAC-CE, RRC, LPP message, etc.) about which Rx hopping pattern the WTRU should use if the WTRU is preconfigured with a list of RX hopping patterns from the network.

In some cases, the WTRU may not receive an indication from the network about which RX hopping pattern to use. In such cases, the WTRU may determine to use one or more of the following methods to determine the RX frequency hopping pattern, based on the preconfigured list of Rx hopping patterns. In examples, the WTRU may use a method that includes determining the RX frequency hopping pattern with the smallest index in the pattern. For example, if the indices range from 1 to 10, the WTRU may choose the pattern corresponding to ID #1. In examples, the WTRU may use a method that includes determining the RX frequency hopping pattern based on a function. The input to the function may be one of the configurations related to positioning or communication (e.g., PRS ID, cell ID, PRS resource ID, RNTI), and the output of the function may be the pattern ID number.

In some cases, if the WTRU determines the RX hopping pattern ID, the WTRU may report the ID associated with the measurements made from the RX hopping pattern. In some cases, if the WTRU is not configured with the list of RX hopping patterns, the WTRU may perform one or more of the following. The WTRU may use a default frequency hopping pattern, which may be preconfigured by the network. The WTRU may select the frequency hopping pattern based on the BWP, band, and/or center frequency, in which the most recent uplink transmission (e.g., PUCCH, PUSCH, UL RS) is implemented. For example, the WTRU may choose a frequency hopping pattern, in which the first Rx hop is closest to the center frequency at which the latest uplink transmission is implemented. The WTRU may perform measurements on the band preconfigured by the network, in which the band is indicated by the minimum and/or maximum frequency unit. The band preconfigured by the network may not include Rx hopping. In some cases, the minimum and maximum frequency unit may be RE number, RB number, or Hz.

In some cases, the WTRU may be configured for a combination of Tx and Rx hopping. The WTRU may receive configurations for PRS hopping (e.g., hopping patterns, a Hop BW, etc.). In some cases, the WTRU may perform measurements on PRS hops based on the configuration for PRS hopping. In some cases, the WTRU may receive Rx hopping patterns, Tx hopping patterns, a Hop BW, and/or etc. In such cases, the WTRU may perform measurements on normal PRS. For example, the WTRU may perform measurements on one or more of PRS for legacy WTRUs, PRS with bandwidth configured for normal WTRUs, and/or PRS without hops. If the WTRU is not configured with either Tx or Rx hopping pattern, the WTRU may perform measurements on normal PRS based on the default Rx hopping pattern and/or a default measurement range.

In some cases, the WTRU may determine the Rx hopping pattern or measurement range based on a broadcast (e.g., SIB), groupcast, and/or unicast. The Rx hopping pattern or measurement range may be the default pattern or range. The WTRU may determine the Rx hopping pattern or measurement range based on cell specific information (e.g., cell specific broadcast information, SIB, etc.). For example, the network may support a transmission of normal PRS for designated cells. In such cases, the WTRU in the designated cells may determine that PRS frequency hopping pattern is not supported. The WTRU may determine that the PRS frequency hopping pattern is not supported based on broadcast information. The WTRU may determine to either perform Rx hopping or measure a specific measurement range. In examples, the WTRU may determine that the cells support Rx hopping pattern-based measurements via, for example, broadcast, RRC, and/or LPP messages. The WTRU may perform measurements based on a present and/or preconfigured Rx hopping pattern.

In some cases, the WTRU may be configured for an adaptive measurement for Rx hopping. In some cases, the WTRU may receive a PRS configuration from the network, a threshold a default Rx measurement range (e.g., measurement BW), and/or PRS configurations (e.g., a PRS index, a PRS resource index, and the like). In examples, an Rx hopping pattern may include a set of at least two hops per hopping occasion. A hopping occasion may correspond to a time unit (e.g., a symbol or slot) or time span of multiple time units. In examples, a first hop in a hopping occasion may correspond to a first set of frequency resources and a second hop in a hopping occasion may correspond to a second set of frequency resources that overlaps or does not overlap with the first set of frequency resources. In an example, the second set of frequency resources may not be the same as the first set of frequency resources.

In some cases, the WTRU may be configured with a DL-AoD positioning method by the network. If the WTRU receives a list of RX hopping patterns in which each hopping pattern is associated with an ID (e.g., index), the WTRU may determine an RX hopping pattern from the list. In examples, if the WTRU receives an indication from the network indicating an index for a RX hopping pattern, the WTRU may determine the RX hopping pattern to be the indicated RX hopping pattern. In examples, if the WTRU does not receive an indication from the network indicating an index for a RX hopping pattern, the WTRU may determine the RX hopping pattern based on a selection criterion in which the selection criteria may be configured. A selection criterion may include, for example, a first RX hopping pattern in the preconfigured list, based on PRS index.

In some cases, the WTRU may receive an LOS indicator for the PRS from the NW. If the LOS indicator for the PRS is above or equal to the threshold, the WTRU may perform one RSRP measurement based on measurements from all hops in an occasion. For example, the WTRU may perform the RSRP measurement based on an average of the RSRP measurements from all hops in the occasion. If the LOS indicator is below the threshold, the WTRU may perform one RSRP measurement per RX hop in the occasion and associates a hop index with each measurement.

In some cases, the WTRU may report the RSRP measurement(s) to the network. If the RX hopping pattern is determined by the WTRU, the WTRU may report the RX hopping pattern index to the network. If the WTRU makes RSRP measurement per hop in the occasion, the WTRU may report the hop index along with each measurement.

In some cases, if the WTRU did not receive a list of RX hopping patterns, the WTRU may perform RSRP measurement(s) using the default Rx measurement range.

In some cases, the WTRU may be configured for adaptive measurements for Rx hopping, such as timing measurements. In some cases, the WTRU may perform Rx hopping for timing-based measurements (e.g., RSTD). The WTRU may determine RSTD based on the determined Rx hopping pattern. The WTRU may determine the Rx hopping pattern based on criteria and/or procedure described herein.

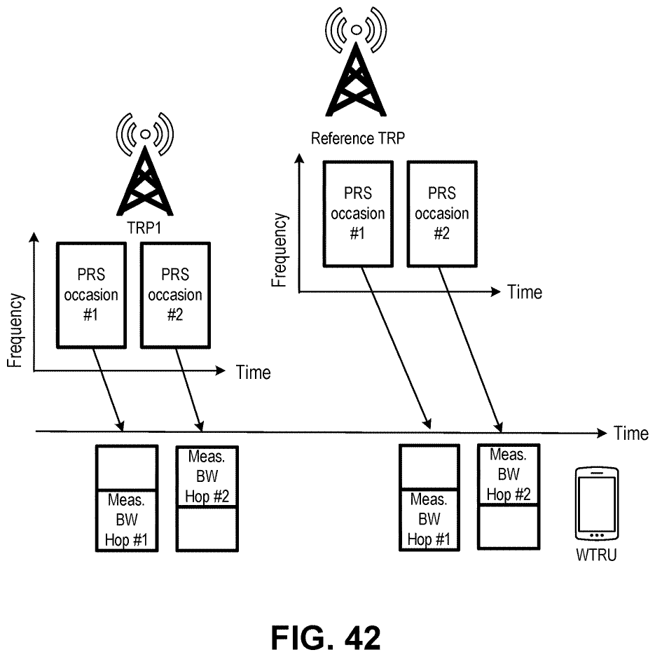

In some cases, the WTRU may determine RSTD based on coherently combined measurements and/or pairwise measurement. FIG. 42 illustrates an example in which the WTRU receives two PRS occasions from reference TRP and target TRP (TRP1). The WTRU may perform a measurement on the received PRS based on the determined Rx hopping pattern. For example, the Rx hopping pattern may include 2 hops.

In some cases, the WTRU may combine measurements obtained from Rx hops coherently. For example, the WTRU may combine measurements based on averaging the measurements. In examples, the WTRU may combine the measurements based on the earliest ToA or the latest ToA. For example, the WTRU may determine ToA of PRS transmitted from TRP1 based on Rx hop #1 and Rx hop #2, which are namely ToA1 and ToA2. The WTRU may determine the coherently combined ToA by ToA_t=(ToA1+ToA2)/2. Similarly, for PRS transmitted from the reference TRP, the WTRU may determine a coherently combined ToA by ToA_r=(ToAr1+ToAr2)/2 in which ToAr1 and ToAr2 are ToA determined from Rx hop #1 and Rx hop #2, respectively. The WTRU may report the coherently combined RSTD to the network.

In some cases, the WTRU may compute RSTD per hop-pair in which the hop-pair may be configured by the network. The WTRU may receive the configuration of pairing from the network. The WTRU may pair ToA measurements from Rx hop #1 applicable to PRS transmitted from TRP1 and reference TRP (e.g., similar to the pairing configuration for Tx hopping as described herein), (e.g., as illustrated in FIG. 42). Similarly, the WTRU may pair ToA measurements from Rx hop #2 applicable to PRS transmitted from TRP1 and reference TRP. The WTRU may determine the pairwise RSTD(s), as RSTD1=ToAr1−ToAr1 and RSTD2=ToAr2−ToAr2. The WTRU may report one of or both RSTD1 and RSTD2 to the network.

In some cases, the WTRU may coherently combine RSTD or report pairwise RSTD based on one or more of the following. The WTRU may coherently combine RSTD or report pairwise RSTD for the cases in which the WTRU is configured to use the measurement method. For example, the WTRU may be configured to perform RSTD measurements per hop-pair. In examples, if the LOS indicator associated with the PRS transmitted from the reference and/or target TRP is less or equal to the preconfigured threshold, the WTRU may perform RSTD measurements per hop-pair. If the LOS indicator associated with the PRS transmitted from the reference TRP is above the preconfigured threshold, the WTRU may perform one RSTD measurement. If the RSRP of the PRS transmitted from reference/target TRP is less or equal to the preconfigured threshold, the WTRU may perform RSTD measurements per hop-pair. The RSRP for PRS may be determined by coherently combining RSRP measurements from Rx hops. If RSRP of the PRS transmitted from the reference TRP is above the preconfigured threshold, the WTRU may perform one RSTD measurement. If the WTRU detects more than one path for the PRS transmitted from the reference/target TRP, the WTRU may perform RSTD measurements per hop-pair. If the WTRU detects one path for PRS transmitted from reference/target TRP, the WTRU may perform one RSTD measurement.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, WTRU, terminal, base station, RNC, or any host computer.

What is claimed is:

1. A wireless transmit/receive unit (WTRU) comprising:
a processor configured to:
receive configuration information indicating a configured bandwidth for performing positioning reference signal (PRS) measurements, wherein the configured bandwidth for performing PRS measurements is greater than a receiving bandwidth of the WTRU;
receive a first PRS transmission using a first portion of the configured bandwidth, wherein the first portion of the configured bandwidth corresponds to a first frequency hop associated with the configured bandwidth;
receive a second PRS transmission using a second portion of the configured bandwidth, wherein the second portion of the configured bandwidth corresponds to a second frequency hop of the configured bandwidth;
determine a PRS measurement based on the first PRS transmission and the second PRS transmission; and
send the PRS measurement and an indication that the PRS measurement is based on more than one frequency hop.

2. The WTRU of claim 1, wherein the second portion of the configured bandwidth is different from the first portion of the configured bandwidth.

3. The WTRU of claim 1 wherein the first portion and the second portion of the configured bandwidth overlap in frequency.

4. The WTRU of claim 1, wherein the WTRU is a reduced capability WTRU that is not configured to perform PRS measurements across an entirety of the configured bandwidth during a given time instance.

5. The WTRU of claim 1, wherein the processor is configured to receive the first PRS transmission and the second PRS transmission in consecutive hops.

6. The WTRU of claim 1, wherein the PRS measurement comprises a reference signal time difference (RSTD), reference signal received power (RSRP), or WTRU Receive-Transmit time difference measurement.

7. The WTRU of claim 1, wherein the indication that the PRS measurement is based on more than one frequency hop is indicated by a single bit.

8. The WTRU of claim 1, wherein the indication that the PRS measurement is based on more than one frequency hop comprises an integer or real number.

9. The WTRU of claim 1, wherein the PRS measurement is based on a first measurement based on the first PRS transmission and a second measurement determined based on the second PRS transmission.

10. The WTRU of claim 1, wherein the processor is configured to:
determine raw measurements from both of the first PRS transmission and the second PRS transmission; and
calculate a minimum, maximum, or average of the raw measurements to determine the PRS measurement.

11. A method to be performed by a wireless transmit/receive unit (WTRU), the method comprising:
receiving configuration information indicating a configured bandwidth for performing positioning reference signal (PRS) measurements, wherein the configured bandwidth for performing PRS measurements is greater than a receiving bandwidth of the WTRU;
receiving a first PRS transmission using a first portion of the configured bandwidth, wherein the first portion of the configured bandwidth corresponds to a first frequency hop associated with the configured bandwidth;
receiving a second PRS transmission using a second portion of the configured bandwidth, wherein the second portion of the configured bandwidth corresponds to a second frequency hop of the configured bandwidth;
determining a PRS measurement based on the first PRS transmission and the second PRS transmission; and
sending the PRS measurement and an indication that the PRS measurement is based on more than one frequency hop.

12. The method of claim 11, wherein the second portion of the configured bandwidth is different from the first portion of the configured bandwidth.

13. The method of claim 11, wherein the first portion and the second portion of the configured bandwidth overlap in frequency.

14. The method of claim 11, wherein the WTRU is a reduced capability WTRU that is not configured to perform PRS measurements across an entirety of the configured bandwidth during a given time instance.

15. The method of claim 11, wherein the first PRS transmission and the second PRS transmission are received in consecutive hops.

16. The method of claim 11, wherein the PRS measurement comprises a reference signal time difference (RSTD), reference signal received power (RSRP), or WTRU Receive-Transmit time difference measurement.

17. The method of claim 11, wherein the indication that the PRS measurement is based on more than one frequency hop is indicated by a single bit.

18. The method of claim 11, wherein the indication that the PRS measurement is based on more than one frequency hop comprises an integer or real number.

19. The method of claim 11, wherein the PRS measurement comprises a first measurement based on the first PRS transmission and a second measurement determined based on the second PRS transmission.

20. The method of claim 11, wherein the PRS measurement is determined by determining raw measurements from both of the first PRS transmission and the second PRS transmission; and calculating a minimum, maximum, or average of the raw measurements.

21. The WTRU of claim 1, wherein the WTRU is a reduced capability WTRU, wherein the receiving bandwidth is defined by a capability of the WTRU, and/or wherein the receiving bandwidth of the WTRU is a part of the configured bandwidth for performing PRS measurements.

22. The method of claim 11, wherein the WTRU is a reduced capability WTRU, wherein the receiving bandwidth is defined by a capability of the WTRU, and/or wherein the receiving bandwidth of the WTRU is a part of the configured bandwidth for performing PRS measurements.
